(19) United States
(12) Patent Application Publication
(10) Pub. No.: US 2025/0350353 A1
(43) Pub. Date: Nov. 13, 2025

(54) DYNAMIC DEVICE MULTICAST BROADCAST RECEPTION

(71) Applicant: Dell Products L.P., Round Rock, TX (US)

(72) Inventor: Ali Esswie, Calgary (CA)

(21) Appl. No.: 18/661,161

(22) Filed: May 10, 2024

(51) Int. Cl. H04B 7/185; H04B 7/06

(52) U.S. Cl. CPC H04B 7/18543; H04B 7/06968; H04B 7/18532

(57) ABSTRACT

A terrestrial radio network node may request that delivery of a portion of a communication session between the terrestrial node and a user equipment be delegated to a non-terrestrial radio network node. Based on quasi colocation information included in, and responsive to, a delegation request from the terrestrial node, the non-terrestrial node may determine offset/adjustment values corresponding to terrestrial performance parameter values indicated in the delegation request and may transmit the offset/adjustment values to the terrestrial node, which may transmit the offset adjustment values to the user equipment. The user equipment may adjust configuration information based on the offset adjustment values and receive, from the non-terrestrial node, delegated data traffic associated with the communication session according to adjusted configuration information and according to terrestrial resources schedule, by the terrestrial node, before delegation. The user equipment may continue to receive control messages from the terrestrial node.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by a non-terrestrial radio network node comprising at least one processor, receiving, from a network element associated with at least one terrestrial radio network node, at least one delegated traffic delivery request, indicative of a request that the non-terrestrial radio network node facilitate delivering of terrestrial traffic, corresponding to at least one terrestrial traffic flow, wherein the at least one terrestrial radio network node facilitates delivery of the at least one terrestrial traffic flow to at least one user equipment. Responsive to the at least one delegated traffic delivery request, the method may further comprise facilitating, by the non-terrestrial radio network node, receiving terrestrial traffic corresponding to the at least one terrestrial traffic flow to result in delegated traffic, and facilitating, by the non-terrestrial radio network node, transmitting, to at least one of the at least one user equipment, the delegated traffic. The terrestrial traffic may comprise, or may be associated with, multicast broadcast service traffic.

The at least one delegated traffic delivery request may be further indicative of at least one terrestrial radio channel performance parameter value associated with at least one terrestrial radio channel being used by the at least one terrestrial radio network node to deliver the terrestrial traffic to the at least one user equipment.

In an embodiment, based on at least one non-terrestrial radio channel performance parameter value that corresponds to delivery of non-terrestrial downlink traffic from the non-terrestrial radio network node to the at least one user equipment, the method may further comprise determining, by the non-terrestrial radio network node, at least one non-terrestrial radio channel performance parameter adjustment value.

In an embodiment, the method may further comprise facilitating, by the non- terrestrial radio network node, transmitting, to at least one of the at least one terrestrial radio network node, at least one non-terrestrial radio channel performance parameter adjustment message comprising the at least one non-terrestrial radio channel performance parameter adjustment value.

In an embodiment, the method may further comprise adjusting, by the non-terrestrial radio network node, the at least one terrestrial radio channel performance parameter value according to at least one non-terrestrial radio channel performance parameter adjustment value to result in at least one adjusted non-terrestrial radio channel performance parameter value. The facilitating of the transmitting of the delegated traffic may comprise facilitating transmitting the delegated traffic according to the at least one adjusted non-terrestrial radio channel performance parameter value.

The at least one terrestrial radio channel performance parameter value comprises at least one of: a terrestrial doppler shift value, a terrestrial doppler spread value, a terrestrial delay value, or a terrestrial delay spread value, and wherein the at least one non-terrestrial radio channel performance parameter value comprises at least one of: a non-terrestrial doppler shift value, a non-terrestrial doppler spread value, a non-terrestrial delay value, or a non-terrestrial delay spread value. The at least one non-terrestrial radio channel performance parameter adjustment value may be based on a delay difference between the non-terrestrial delay value and the terrestrial delay value.

The at least one delegated traffic delivery request may further comprise at least one terrestrial resource indication indicative of at least one terrestrial time resource or at least one terrestrial frequency resource corresponding to the delivering, by the at least one terrestrial radio network node, of the terrestrial traffic. The at least one delegated traffic delivery request may further comprise at least one quasi colocation information type indication indicative of at least one quasi colocation information type corresponding to the delivering, by the at least one terrestrial radio network node, of the terrestrial traffic.

The at least one terrestrial radio channel performance parameter value may correspond to the at least one quasi colocation information type. The at least one adjusted non-terrestrial radio channel performance parameter value may correspond to the at least one quasi colocation information type. The delegated traffic may comprise terrestrial data channel traffic to result in delegated data traffic. The delivering of the delegated data traffic by the non-terrestrial radio network node to the at least one user equipment may be facilitated by, according to, or in correspondence with, the at least one quasi colocation information type. The delegated traffic may not comprise terrestrial control channel traffic thus resulting in nondelegated control traffic, the delivery of which, by the at least one of the at least one terrestrial radio network node to the at least one user equipment, may be facilitated by, according to, or in correspondence with, the at least one quasi colocation information type. The at least one terrestrial radio channel performance parameter value may correspond to the at least one quasi colocation information type, and the at least one adjusted non-terrestrial radio channel performance parameter value may correspond to the at least one quasi colocation information type. The transmitting of the delegated traffic may further comprise transmitting of the delegated traffic according to the at least one terrestrial time resource or according to the at least one terrestrial frequency resource.

The at least one user equipment may comprise at least one user equipment that is incompatible with operation with respect to non-terrestrial frequency resources (e.g., the at least one user equipment may be referred to as non-terrestrial-incapable).

In an embodiment, the at least one user equipment may comprise at least one user equipment that is compatible with operation with respect to non-terrestrial frequency resources to result in at least one non-terrestrial-capable user equipment, wherein the delegated traffic comprises terrestrial data channel traffic and terrestrial control channel traffic to result in delegated data traffic and delegated control traffic, and wherein the facilitating of the transmitting of the delegated traffic comprises facilitating the transmitting of the delegated data traffic and the delegated control traffic to the non-terrestrial-capable user equipment according to at least one non-terrestrial frequency resource.

In an embodiment, the method may further comprise determining, by the non-terrestrial radio network node, at least one non-terrestrial beam corresponding to the at least one terrestrial radio network node to result in at least one determined non-terrestrial beam. The delegated traffic may be transmitted according to the at least one determined non-terrestrial beam.

In another example embodiment, a non-terrestrial radio network node may comprise at least one processor configured to process executable instructions that, when executed by the at least one processor, facilitate performance of operations that may comprise receiving, from a network element associated with a terrestrial radio network node, a delegated traffic delivery request, indicative of a request that the non-terrestrial radio network node facilitate delivery of terrestrial traffic, corresponding to at least one terrestrial traffic flow being delivered by the terrestrial radio network node to at least one user equipment, and indicative of terrestrial transmission information. Responsive to the delegated traffic delivery request, the method may further comprise receiving the terrestrial traffic to result in delegated traffic, and transmitting, to at least one of the at least one user equipment, the delegated traffic according to the terrestrial transmission information.

The terrestrial transmission information may comprise at least one of: at least one terrestrial radio channel performance parameter indication indicative of at least one terrestrial radio channel performance parameter value associated with at least one terrestrial radio channel being used by the terrestrial radio network node to deliver the terrestrial traffic to the at least one user equipment; at least one terrestrial resource indication indicative of at least one terrestrial time resource or at least one terrestrial frequency resource corresponding to transmitting, by the terrestrial radio network node, of the terrestrial traffic; or at least one quasi colocation information type indication indicative of at least one quasi colocation information type corresponding to transmitting by the terrestrial radio network node, of the terrestrial traffic.

In an embodiment, based on at least one non-terrestrial radio channel performance parameter value that corresponds to delivery of non-terrestrial downlink traffic from the non-terrestrial radio network node to the at least one user equipment, the operations may further comprise determining at least one non-terrestrial radio channel performance parameter adjustment value, and transmitting, to the terrestrial radio network node, a non-terrestrial radio channel performance parameter adjustment message comprising the at least one non-terrestrial radio channel performance parameter adjustment value to be indicated by the terrestrial radio network node to the at least one user equipment to facilitate the at least one user equipment receiving the delegated traffic.

In yet another example embodiment, a non-transitory machine-readable medium may comprise executable instructions that, when executed by at least one processor of a non-terrestrial radio network node, facilitate performance of operations that may comprise receiving, from a network element associated with a terrestrial radio network node, a delegated traffic delivery request, indicative of a request that the non-terrestrial radio network node facilitate delivery of terrestrial data traffic, corresponding to at least one terrestrial multicast traffic flow being delivered by the terrestrial radio network node to at least one user equipment, and indicative of terrestrial transmission information. Responsive to the delegated traffic delivery request, the operations may further comprise receiving multicast data traffic corresponding to the at least one terrestrial multicast traffic flow to result in delegated multicast data traffic, and transmitting, to at least one of the at least one user equipment, the delegated multicast data traffic according to the terrestrial transmission information. The multicast data traffic may be received from at least one of: the terrestrial radio network node, a non-terrestrial gateway corresponding to the non-terrestrial radio network node. The multicast data traffic may be directed to the non-terrestrial radio network node by at least one of: a core network element, a terrestrial/non-terrestrial shared network element, or the terrestrial radio network node.

In another example embodiment, a method may comprise facilitating, by a terrestrial radio network node comprising at least one processor, directing, to at least one non-terrestrial radio network node, at least one delegated traffic delivery request, indicative of a request that the at least one non-terrestrial radio network node facilitate delivering of terrestrial traffic, corresponding to at least one terrestrial traffic flow, wherein the terrestrial radio network node facilitates delivery of the at least one terrestrial traffic flow to at least one user equipment. Responsive to the at least one delegated traffic delivery request, the method may further comprise facilitating, by the terrestrial radio network node, receiving at least one non-terrestrial radio channel performance parameter adjustment message, directed to the terrestrial radio network node by at least one of the at least one non-terrestrial radio network node, comprising at least one non-terrestrial radio channel performance parameter adjustment value. The method may further comprise facilitating, by the terrestrial radio network node, directing, to the at least one of the at least one non-terrestrial radio network node, terrestrial traffic corresponding to the at least one terrestrial traffic flow to result in directed delegated traffic to be delivered to at least one of the at least one user equipment by at least one of the at least one non-terrestrial radio network node, wherein delivering the directed delegated traffic to the at least one of the at least one user equipment is to be facilitated by the at least one of the at least one non-terrestrial radio network node based on the at least one non-terrestrial radio channel performance parameter adjustment value.

In an embodiment, the method may further comprise facilitating, by the terrestrial radio network node, receiving, from at least one network element, the at least one non-terrestrial radio channel performance parameter adjustment value. The at least one non-terrestrial radio channel performance parameter adjustment message may be received from at least one of: the at least one non-terrestrial radio network node or at least one of the at least one network element. The at least one network element may comprise at least one of: at least one core network element, at least one terrestrial/non-terrestrial shared network element, or at least one gateway associated with the at least one non-terrestrial radio network node.

In an embodiment, the method may further comprise facilitating, by the terrestrial radio network node, transmitting, to the at least one user equipment, the at least one non-terrestrial radio channel performance parameter adjustment value.

In an embodiment, the method may further comprise facilitating, by the terrestrial radio network node, transmitting to at least one of the at least one user equipment, a terrestrial radio channel performance parameter value report request comprising a request that the at least one user equipment direct at least one terrestrial radio channel performance parameter value report to the terrestrial radio network node, and responsive to the terrestrial radio channel performance parameter value report request, facilitating, by the terrestrial radio network node, receiving, from at least one of the at least one user equipment, at least one terrestrial radio channel performance parameter value report comprising at least one terrestrial radio channel performance parameter value indication indicative of at least one terrestrial radio channel performance parameter value corresponding to receiving of the terrestrial traffic by the at least one user equipment. The at least one terrestrial radio channel performance parameter value may comprise at least one of: a terrestrial doppler shift value, a terrestrial doppler spread value, a terrestrial delay value, or a terrestrial delay spread value; and wherein the at least one non-terrestrial radio channel performance parameter adjustment value is based on at least one of: a non-terrestrial doppler shift value, a non-terrestrial doppler spread value, a non-terrestrial delay value, or a non-terrestrial delay spread value.

In an embodiment, the at least one delegated traffic delivery request may comprise the at least one terrestrial radio channel performance parameter value indication to be usable by the at least one non-terrestrial radio network node to determine the at least one non-terrestrial radio channel performance parameter adjustment value. The method may further comprise determining, by the terrestrial radio network node, at least one composite terrestrial radio channel performance parameter value based on multiple terrestrial radio channel performance parameter values received via multiple terrestrial radio channel performance parameter value reports from multiple user equipment, wherein the determining of the at least one composite terrestrial radio channel performance parameter value is based on at least one of: at least one average of the multiple terrestrial radio channel performance parameter values, at least one worst terrestrial radio channel performance parameter value of the terrestrial radio channel performance parameter values, or a filtered terrestrial radio channel performance parameter value of the terrestrial radio channel performance parameter values. The at least one terrestrial radio channel performance parameter value indication may comprise at least one composite terrestrial radio channel performance parameter value indication indicative of the at least one composite terrestrial radio channel performance parameter value.

In an embodiment, the method may further comprise facilitating, by the terrestrial radio network node, transmitting, to at least one of the at least one user equipment, the at least one non-terrestrial radio channel performance parameter adjustment value to be usable by the at least one user equipment to receive, from the at least one non-terrestrial radio network node, the directed delegated traffic.

In an embodiment, the at least one delegated traffic delivery request may further comprise at least one terrestrial resource indication indicative of at least one terrestrial time resource or at least one terrestrial frequency resource corresponding to delivery, by the terrestrial radio network node, of the terrestrial traffic. The at least one delegated traffic delivery request may further comprise at least one quasi colocation information type indication indicative of at least one quasi colocation information type corresponding to delivery, by the at least one the terrestrial radio network node, of the terrestrial traffic. The directed delegated traffic may comprise data traffic corresponding to the at least one terrestrial traffic flow. The method further comprises avoiding, by the terrestrial radio network node, directing of control channel traffic corresponding to the at least one terrestrial traffic flow to the at least one non-terrestrial radio network node to result in non-delegated control channel traffic. The at least one quasi colocation information type may correspond to delivery, by the terrestrial radio network node, of the non-delegated control traffic to the at least one user equipment, and wherein the at least one quasi colocation information type indication is to be usable, by the at least one non-terrestrial radio network node, to determine the at least one non-terrestrial radio channel performance parameter adjustment value.

In an embodiment, the directing to the at least one non-terrestrial radio network node of the at least one delegated traffic delivery request may further comprise determining at least one of the at least one non-terrestrial radio network node corresponding to at least one non-terrestrial beam pattern that overlaps at least one terrestrial coverage area corresponding to the terrestrial radio network node to result in at least one determined non-terrestrial radio network node. The at least one non-terrestrial radio network node to which the at least one delegated traffic delivery request is directed is the at least one determined non-terrestrial radio network node.

In an embodiment, the at least one user equipment may comprise at least one user equipment that is incompatible with operation with respect to non-terrestrial frequency resources.

In another example embodiment, a terrestrial radio network node may comprise at least one processor configured to process executable instructions that, when executed by the at least one processor, facilitate performance of operations that may comprise directing, to a non-terrestrial radio network node, a delegated traffic delivery request, indicative of a request that the non-terrestrial radio network node facilitate delivering of terrestrial traffic, corresponding to at least one terrestrial traffic flow. The terrestrial radio network node may facilitate delivery of the at least one terrestrial traffic to at least one user equipment. Responsive to the delegated traffic delivery request, the operations may further comprise receiving a non-terrestrial radio channel performance parameter adjustment message, directed to the terrestrial radio network node by the non-terrestrial radio network node, comprising at least one non-terrestrial radio channel performance parameter adjustment value. The operations may further comprise directing, to the non-terrestrial radio network node, terrestrial traffic corresponding to the at least one terrestrial traffic flow to result in directed delegated traffic to be delivered to at least one of the at least one user equipment by the non-terrestrial radio network node, wherein delivering the directed delegated traffic to the at least one of the at least one user equipment is to be facilitated by the non-terrestrial radio network node based on the at least one non-terrestrial radio channel performance parameter adjustment value.

In an embodiment, the operations may further comprise transmitting to at least one of the at least one user equipment, a terrestrial radio channel performance parameter value report request comprising a request that the at least one user equipment direct at least one terrestrial radio channel performance parameter value report to the terrestrial radio network node. Responsive to the terrestrial radio channel performance parameter value report request, the operations may further comprise receiving, from at least one of the at least one user equipment, at least one terrestrial radio channel performance parameter value report comprising at least one terrestrial radio channel performance parameter value indication indicative of at least one terrestrial radio channel performance parameter value corresponding to receiving, by the at least one user equipment, of the terrestrial traffic. The at least one terrestrial radio channel performance parameter value may comprise at least one of: a terrestrial doppler shift value, a terrestrial doppler spread value, a terrestrial delay value, or a terrestrial delay spread value; and wherein the at least one non-terrestrial radio channel performance parameter adjustment value is based at least one of: a non-terrestrial doppler shift value, a non-terrestrial doppler spread value, a non-terrestrial delay value, or a non-terrestrial delay spread value. The delegated traffic delivery request may comprise the at least one terrestrial radio channel performance parameter value indication to be usable by the non-terrestrial radio network node to determine the at least one non-terrestrial radio channel performance parameter adjustment value.

In an embodiment, the operations may further comprise transmitting, to at least one of the at least one user equipment, the at least one non-terrestrial radio channel performance parameter adjustment value to be usable by the at least one user equipment to receive, from the non-terrestrial radio network node, the directed delegated traffic.

In yet another example embodiment, a non-transitory machine-readable medium may comprise executable instructions that, when executed by at least one processor of a terrestrial radio network node, may facilitate performance of operations that may comprise receiving, from at least one user equipment, at least one terrestrial radio channel performance parameter value report comprising at least one terrestrial radio channel performance parameter value indication indicative of at least one terrestrial radio channel performance parameter value corresponding to communication of terrestrial traffic to the at least one user equipment. The operations may further comprise directing, to a non-terrestrial radio network node, a delegated traffic delivery request, indicative of a request that the non-terrestrial radio network node facilitate communication of terrestrial data traffic, corresponding to the terrestrial traffic, to at least one of the at least one user equipment, to result in requested delegated data traffic. Responsive to the delegated traffic delivery request, the operations may further comprise receiving a non-terrestrial radio channel performance parameter adjustment message, directed to the terrestrial radio network node by the non-terrestrial radio network node, comprising at least one non-terrestrial radio channel performance parameter adjustment value, and transmitting, to the at least one of the at least one user equipment, the at least one non-terrestrial radio channel performance parameter adjustment value to be usable by the at least one of the at least one user equipment to receive, from the non-terrestrial radio network node, the requested delegated data traffic. The operations may further comprise directing, to the non-terrestrial radio network node, the requested delegated data traffic to result in directed delegated data traffic to be communicated to the at least one of the at least one user equipment by the non-terrestrial radio network node. Communication of the directed delegated data traffic to the at least one of the at least one user equipment maybe intended to be facilitated by the non-terrestrial radio network node based on the at least one non-terrestrial radio channel performance parameter adjustment value.

In an embodiment, the operations further comprise avoiding, by the terrestrial radio network node, directing of control channel traffic, corresponding to the terrestrial traffic, to the non-terrestrial radio network node to result in non-delegated control channel traffic.

At least one quasi colocation information type may correspond to delivery, by the terrestrial radio network node, of the non-delegated control traffic to the at least one of the at least one user equipment. At least one quasi colocation information type indication indicative of the at least one quasi colocation information type maybe intended to be usable, by the non-terrestrial radio network node, to determine the at least one non-terrestrial radio channel performance parameter adjustment value.

In another example embodiment, a method may comprise transmitting, by a user equipment comprising at least one processor to a terrestrial radio network node, at least one terrestrial radio channel performance parameter value report comprising at least one terrestrial radio channel performance parameter value indication indicative of at least one terrestrial radio channel performance parameter value, corresponding to receiving, by the user equipment from the terrestrial radio network node, traffic associated with at least one terrestrial traffic flow. The method may further comprise receiving, by the user equipment from the terrestrial radio network node, a radio channel performance parameter adjustment value configuration information message comprising radio channel performance parameter adjustment value configuration information. Responsive to the radio channel performance parameter adjustment value configuration information message, the method may further comprise receiving, from a non-terrestrial radio network node according to the radio channel performance parameter adjustment value configuration information, delegated traffic comprising traffic corresponding to the at least one terrestrial traffic flow. The radio channel performance parameter adjustment value configuration information may comprise at least one non-terrestrial radio channel performance parameter adjustment value corresponding to delivery, by the non-terrestrial radio network node, of traffic to different user equipment. The at least one terrestrial radio channel performance parameter value may comprise at least one of: a terrestrial doppler shift value, a terrestrial doppler spread value, a terrestrial delay value, or a terrestrial delay spread value, and wherein the radio channel performance parameter adjustment value configuration information is based on at least one of: a non-terrestrial doppler shift value, a non-terrestrial doppler spread value, a non-terrestrial delay value, or a non-terrestrial delay spread value.

In an embodiment, the user equipment may be incapable of establishing a connection with the non-terrestrial radio network node. The radio channel performance parameter adjustment value configuration information may comprise at least one non-terrestrial adjustment value. The method may further comprise applying, by the user equipment, the at least one non-terrestrial adjustment value to the at least one terrestrial radio channel performance parameter value to result in at least one adjusted radio channel performance parameter value. The receiving of the delegated traffic may further comprise receiving the delegated traffic according to at least one terrestrial resource, with respect to which the user equipment is configured to receive, from the terrestrial radio network node, the at least one terrestrial traffic flow, and according to the at least one adjusted radio channel performance parameter value. The at least one terrestrial resource may comprise at least one of: a terrestrial frequency or a terrestrial scheduled time. The at least one non-terrestrial adjustment value may comprise at least one of: a non-terrestrial doppler shift adjustment value, a non-terrestrial doppler spread adjustment value, a non-terrestrial delay adjustment value, or a non-terrestrial delay spread adjustment value.

In an embodiment, the applying of the at least one non-terrestrial adjustment value to the at least one terrestrial radio channel performance parameter value to result in the at least one adjusted radio channel performance parameter value may further comprise applying the at least one non-terrestrial adjustment value to the at least one terrestrial radio channel performance parameter value according to a terrestrial quasi colocation information type corresponding to the at least one terrestrial traffic flow.

In an embodiment, the delegated traffic may comprise data traffic corresponding to the at least one terrestrial traffic flow. The method may further comprise receiving, by the user equipment from the terrestrial radio network node, control channel traffic corresponding to the at least one terrestrial traffic flow according to the at least one terrestrial radio channel performance parameter value. The user equipment may receive the delegated traffic according to a terrestrial quasi colocation information type corresponding to the at least one terrestrial traffic flow, and wherein the user equipment receives the control channel traffic according to the terrestrial quasi colocation information type.

In an embodiment, the radio channel performance parameter adjustment value configuration information may comprise at least one of: a non-terrestrial switching request indication, indicative of a non-terrestrial radio network node identifier corresponding to the non-terrestrial radio network node, and indicative that the user equipment is to establish a connection with the non-terrestrial radio network node to at least receive the at least one terrestrial traffic flow from the non-terrestrial radio network node via non-terrestrial resources; or a non-terrestrial quasi colocation type indication indicative of a non-terrestrial quasi colocation type usable for receiving of traffic associated with the at least one terrestrial traffic flow from the non-terrestrial radio network node via non-terrestrial resources.

The user equipment may be capable of establishing a connection with the non-terrestrial radio network node (e.g., the user equipment may be a non-terrestrial-capable user equipment). Responsive to the non-terrestrial switching request indication, the method may further comprise establishing, by the user equipment, a connection with the non-terrestrial radio network node to result in an established non-terrestrial connection, and flushing, by the user equipment, terrestrial quasi colocation type information usable by the user equipment to receive the at least one terrestrial traffic flow from the terrestrial radio network node. The delegated traffic may be received via the established non-terrestrial connection. The established non-terrestrial connection may be established according to the non-terrestrial quasi colocation type indicated in the radio channel performance parameter adjustment value configuration information. The delegated traffic may comprise data traffic and control channel traffic associated with the at least one terrestrial traffic flow.

In another example embodiment, a user equipment may comprise at least one processor configured to process executable instructions that, when executed by the at least one processor, may facilitate performance of operations that may comprise receiving, from a terrestrial radio network node, a terrestrial radio channel performance parameter value report request comprising a request that the user equipment direct at least one terrestrial radio channel performance parameter value report to the terrestrial radio network node. Responsive to the terrestrial radio channel performance parameter value report request, the operations may further comprise transmitting, to the terrestrial radio network node, at least one terrestrial radio channel performance parameter value report comprising at least one terrestrial radio channel performance parameter value indication indicative of at least one terrestrial radio channel performance parameter value corresponding to receiving, by the user equipment from the terrestrial radio network node, traffic associated with at least one terrestrial traffic flow. The operations may further comprise receiving, from the terrestrial radio network node, a radio channel performance parameter adjustment value configuration information message comprising at least one non-terrestrial radio channel performance parameter adjustment value. Responsive to the radio channel performance parameter adjustment value configuration information message, the operations may further comprise receiving, from a non-terrestrial radio network node according to the at least one non-terrestrial radio channel performance parameter adjustment value, delegated traffic comprising traffic corresponding to the at least one terrestrial traffic flow. The at least one terrestrial radio channel performance parameter value comprises at least one of: a terrestrial doppler shift value, a terrestrial doppler spread value, a terrestrial delay value, or a terrestrial delay spread value, and wherein the at least one non-terrestrial radio channel performance parameter adjustment value comprises at least one of: a non-terrestrial doppler shift offset value, a non-terrestrial doppler spread offset value, a non-terrestrial delay offset value, or a non-terrestrial delay spread offset value.

The operations may further comprise, applying the at least one non-terrestrial radio channel performance parameter adjustment value to the at least one terrestrial radio channel performance parameter value to result in at least one adjusted radio channel performance parameter value. The delegated traffic may be received according to at least one terrestrial resource, with respect to which the user equipment is configured to receive, from the terrestrial radio network node, the at least one terrestrial traffic flow, and according to the at least one adjusted radio channel performance parameter value.

In an embodiment, the delegated traffic may comprise delegated data traffic corresponding to the at least one terrestrial traffic flow. The operations may further comprise, receiving, from the terrestrial radio network node, control channel traffic corresponding to the at least one terrestrial traffic flow according to the at least one terrestrial radio channel performance parameter value.

The user equipment may receive, from the non-terrestrial radio network node, the delegated data traffic according to a terrestrial quasi colocation information type corresponding to the at least one terrestrial traffic flow and the user equipment may receive, from the terrestrial radio network node, the control channel traffic corresponding to the at least one terrestrial traffic flow according to the terrestrial quasi colocation information type.

In yet another example embodiment, a non-transitory machine-readable medium may comprise executable instructions that, when executed by at least processor of a user equipment, may facilitate performance of operations that may comprise transmitting, to a terrestrial radio network node, at least one terrestrial radio channel performance parameter value report comprising at least one terrestrial radio channel performance parameter value indication indicative of at least one terrestrial radio channel performance parameter value corresponding to receiving, by the user equipment from the terrestrial radio network node, at least one multicast broadcast service traffic flow, and receiving, from the terrestrial radio network node, a radio channel performance parameter adjustment value configuration information message comprising at least one non-terrestrial radio channel performance parameter offset value. Responsive to the radio channel performance parameter adjustment value configuration information message, the operations may further comprise receiving, from a non-terrestrial radio network node according to the at least one non-terrestrial radio channel performance parameter offset value, delegated data traffic associated with the at least one multicast broadcast service traffic flow.

The delegated data traffic may be received according to at least one terrestrial frequency resource, with respect to which the user equipment may be configured to receive, from the terrestrial radio network node, the at least one multicast broadcast service traffic flow. The delegated data traffic may be received according to the at least one non-terrestrial radio channel performance parameter offset value. The operations may further comprise receiving, from the terrestrial radio network node, control channel traffic corresponding to the at least one multicast broadcast service terrestrial traffic flow according to the at least one terrestrial radio channel performance parameter value.

### BRIEF DESCRIPTION OF THE DRAWINGS

FIG. 1 illustrates wireless communication system environment.

FIG. 2 illustrates an environment with a satellite base station/gateway and satellite that are capable of communication of traffic corresponding to a radio access network.

FIG. 3 illustrates an example environment with a non-terrestrial radio network node facilitating delivering of delegated terrestrial traffic.

FIG. 4 illustrates an example delegated traffic delivery request.

FIG. 5 illustrates an example radio channel performance parameter report format.

FIG. 6 illustrates an example non-terrestrial radio channel performance parameter adjustment message.

FIG. 7 illustrates example non-terrestrial radio channel performance parameter adjustment radio value report formats.

FIG. 8 illustrates non-terrestrial delivering of delegated terrestrial traffic via a determined non-terrestrial beam.

FIG. 9 illustrates an example non-terrestrial radio channel performance parameter adjustment value report message.

FIG. 10A illustrates behavior of user equipment receiving delegated terrestrial traffic according to transparent traffic delivery switching.

FIG. 10B illustrates behavior of user equipment receiving delegated terrestrial traffic according to non-transparent traffic delivery switching.

FIG. 11 illustrates a timing diagram of a non-terrestrial radio network node facilitating delivery of delegated terrestrial traffic.

FIG. 12 illustrates a timing diagram of a terrestrial radio network node facilitating delegating delivery of terrestrial traffic to a non-terrestrial radio network node.

FIG. 13 illustrates a timing diagram of a user equipment facilitating delivery of delegated terrestrial traffic.

FIG. 14 illustrates a flow diagram of an example method to facilitate delivery of delegated terrestrial traffic via a non-terrestrial radio network node.

FIG. 15 illustrates a block diagram of an example method.

FIG. 16 illustrates a block diagram of an example non-terrestrial radio network node.

FIG. 17 illustrates a block diagram of an example non-transitory machine-readable medium.

FIG. 18 illustrates a block diagram of an example method.

FIG. 19 illustrates a block diagram of an example terrestrial radio network node.

FIG. 20 illustrates a block diagram of an example non-transitory machine-readable medium.

FIG. 21 illustrates a block diagram of an example method.

FIG. 22 illustrates a block diagram of an example user equipment.

FIG. 23 illustrates a block diagram of an example non-transitory machine-readable medium.

FIG. 24 illustrates an example computer environment.

FIG. 25 illustrates a block diagram of an example wireless UE.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Artificial intelligence (“AI”) and machine learning (“ML”) models may facilitate performance and operational functionality and improvements in 5G implementation, such as, for example, network automation, optimizing signaling overhead, energy conservation at devices, and traffic-capacity maximization. An artificial intelligence machine learning models (“AI/ML model”) functionality can be implemented and structured in many different forms and with varying vendor-proprietary designs. A 5G radio access network node (“RAN”) of a network to which the user equipment may be attached or with which the user equipment may be registered may manage or control real-time AI/ML model performance at different user equipment devices for various radio functions.

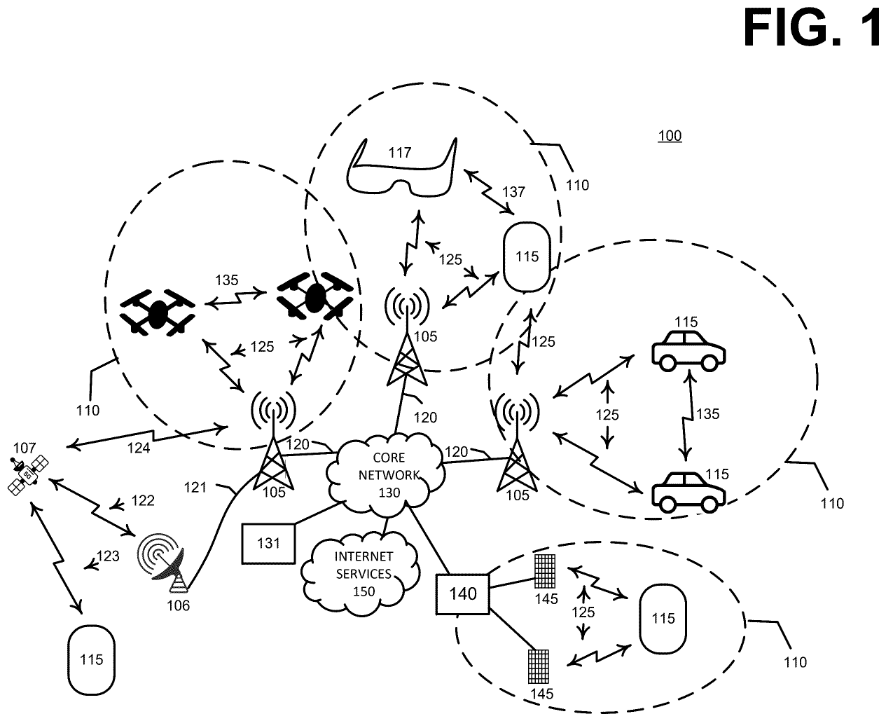

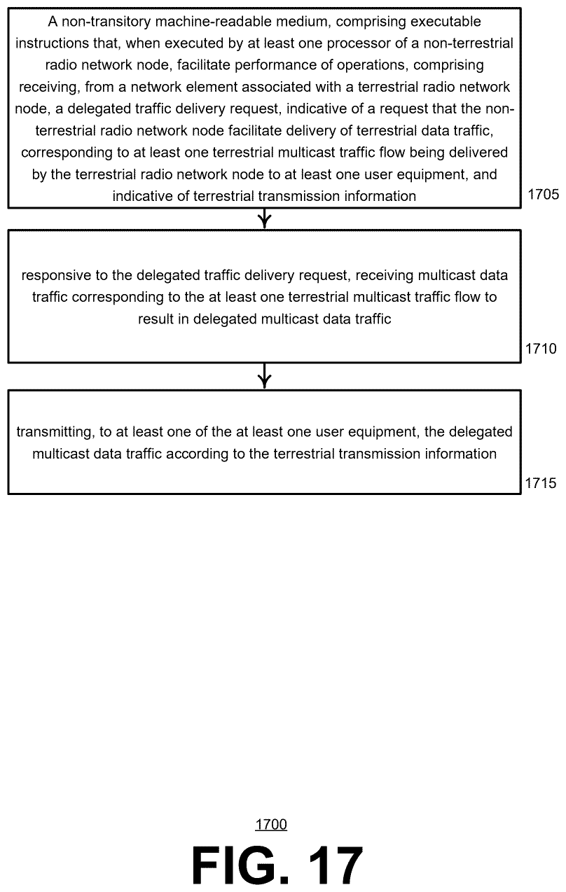

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 17.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The evolution of communication networks has witnessed remarkable advancements over the past decades. A significant extension of 5G's potential may lie beyond the conventional terrestrial infrastructure, giving rise to what are known as Non-Terrestrial Networks (“NTN”).

Non-Terrestrial Networks may encompass a diverse range of technologies and architectures that may comprise space-based, airborne, and maritime platforms to enhance global communication capabilities. Integration of 5G and non-terrestrial environments may facilitate connectivity being established, maintained, and optimized to remote and underserved regions.

Satellites equipped with 5G capabilities constitute an aspect of 5G NTN. Satellites, positioned in low Earth orbit (“LEO”), medium Earth orbit (“MEO”), or geostationary orbit (“GEO”), may form an intricate web of interconnected nodes. The satellites can provide widespread coverage, offering high-speed data connections, low latency communication, and global mobility. Satellites may facilitate broadband access in rural and remote areas, disaster-stricken regions, and on moving vehicles, ships, and aircraft, thus bridging the digital divide.

Satellite-based NTN can bridge connectivity gaps in remote and rural areas, provide disaster recovery communication, and offer enhanced coverage for maritime and aeronautical services. High-altitude platforms and drones equipped with cellular capabilities can serve as temporary network relays for events, emergencies, or areas with signal-strength coverage deficiencies. such applications may benefit not only traditional voice and data services but also for technologies, such as, for example, Internet of Things (“IoT”), wherein connectivity is typically a desirable, or a fundamental requirement.

A non-terrestrial base station 106, which may comprise a satellite antenna, may be coupled to core network 130. Non-terrestrial base station 106 may communicate with satellite 107, which may communicate with a user equipment 115. Non-terrestrial base station 106, which may be referred to as a non-terrestrial network gateway, and satellite 107 may facilitate delivering traffic corresponding to a radio access network, which may comprise RAN nodes 105, core network 130, backhaul links 120, and long-range wireless links 125, to user equipment that may be located beyond coverage of a RAN node 105. Links 121 between RAN nodes 105 and satellite base station/gateway 106 may comprise coaxial, fiber, or wireless links that may be similar to links 120. Links 122 and 124 to satellite node 107, and links 123 from satellite/node 107 to UE 115, may comprise line-of-sight microwave signal transmission. A UE 115 may be configured with at least one antenna, or at least one processor, to facilitate transmitting or receiving microwave signals to/from satellite node 107. Description herein of, or reference herein to, a radio node or a radio network node may be a description of or a reference to either a terrestrial RAN node 105, a non-terrestrial gateway 106, a non-terrestrial satellite node 107, or a combination of one or more of a terrestrial RAN node, a non-terrestrial gateway, or a non-terrestrial satellite. A terrestrial radio network node may be referred to as a “TN” node. Reference to a satellite node, or a non-terrestrial network node (“NTN node”), may comprise a reference to satellite 107, base station gateway 106, or a combination of satellite 107 and base station/gateway 106.

Core network 130 may comprise, or may be communicatively coupled with, shared core entity 131, which may be referred to as a shared core entity node or a shared core node. Shared core entity 131 may be associated with TN node 105 or NTN node 107 and may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105, and thus may facilitate efficient TN-NTN system integration without private terrestrial network information being shared with a non-terrestrial network, and vice versa.

It will be appreciated that although an NTN node may benefit the most from embodiments disclosed herein, techniques disclosed herein may be of benefit to a ground-based RAN node. Thus, use of “radio network node” may be interpreted as referring to a ground-based RAN node or to a satellite node, which may comprise a gateway 106 or a satellite 107.

NTNs can enhance the limited coverage of ground RANs, which makes NTNs cost efficient in remote rural areas, mountainous areas, and generally where ground cellular deployments are either not possible or not cost efficient.

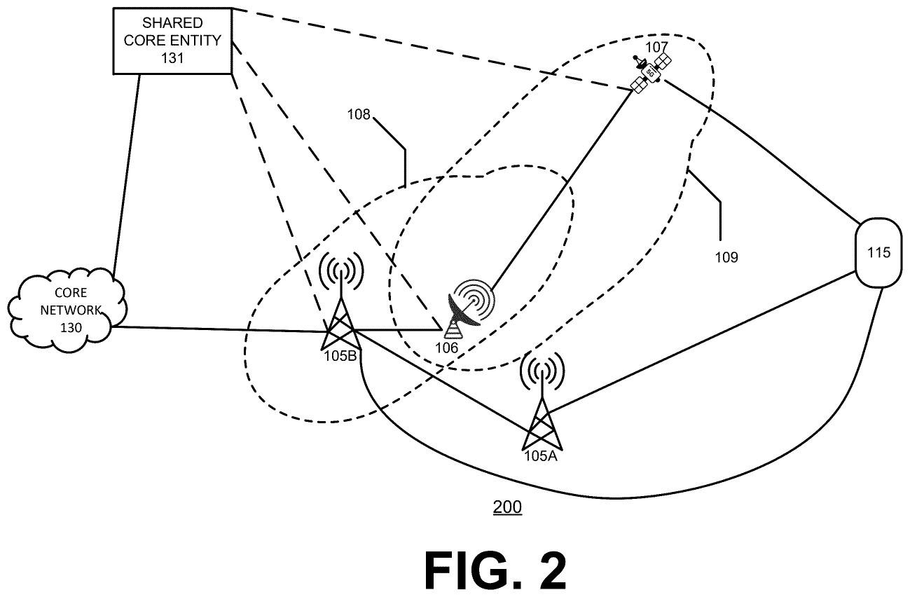

Turning now to FIG. 2, the figure illustrates ground-based RAN node 105, base station 106, and NTN node 107, any one or more of which may be referred to as a radio network node. In reference to some embodiments disclosed herein, reference to a TN node may comprise a reference to node 108, which may comprise one or more of terrestrial RAN node 105 or gateway 106. In reference to some embodiments disclosed herein, reference to an NTN node may comprise a reference to node 109, which may comprise one or more of gateway 106 or satellite 107. In some embodiments, a communication session with UE 115 may be served by RAN node 105. RAN node 105 may communicate directly with satellite node 107 via communication links 124 or via gateway 106 via links 121 and 122.

It may be desirable to implement gNodeB/RAN node functionality on board a non-terrestrial node/satellite node to serve user equipment. A use case for TN-to-NTN integration relates to multicast broadcast service (“MBS”) traffic delivery. MBS services may facilitate efficient delivery of a large quantity of data to user equipment because a RAN node facilitating an MBS communication session delivers the same downlink traffic to a large of number of active user equipment devices (e.g., video streaming at a ceremony, a music concert, or a sporting event) as if the user equipment devices were one user equipment device by executing, with respect to the multiple user equipment, a single scheduling instant, a single resource allocation, and a single control channel exchange. However, multiple adjacent TN RAN nodes may likely be involved in delivering an MBS session, especially for large groups of MBS-session-consuming user equipment wherein individual user equipment of a group of user equipment are geographically spread out, and thus stringent inter-cell resource scheduling, control channel and MBS content delivery coordination must be maintained, which significantly increases the complexity of efficient delivery via MBS delivery via the multiple TN RAN nodes. Because an NTN RAN node may correspond to a larger geographic coverage area, or coverage ‘footprint’, delivery of MBS content to multiple user equipment by an NTN node may be more efficient with respect to resource consumption, and delegation of MBS traffic being facilitated by one or more terrestrial radio network nodes to a non-terrestrial radio network node for delivery thereby may be desirable. When delegated from at least one terrestrial radio network node to an active non-terrestrial radio network node, delivery of MBS content traffic may become more efficient due to the larger coverage footprint corresponding to the NTN RAN nodes (e.g., an NTN RAN node may broadcast an MBS content traffic flow via a single MBS downlink beam that covering an entire group of user equipment that are receiving the MBS content). However, to facilitate seamless delegation of MBS traffic content from terrestrial nodes to a non-terrestrial node, dynamic alignment and adaptation of MBS transmission data and control configuration information is needed. For example, transmission configuration information, which may control, define, facilitate estimation of operation with respect to a channel, may indicated correlation, or a relationship, of first channel conditions corresponding to a first channel and second channel conditions corresponding to a second channel. For example, channel conditions corresponding to a data channel may be correlated with, or related to, conditions corresponding to a control channel or a reference signal channel according to a special predefined relationship (e.g., values corresponding to channel performance parameters associated with, or specified by, a quasi colocation information type). When a user equipment device estimates control channel parameter information that results in successful decoding and receiving of control channel traffic transmitted from a RAN node, or when the user equipment successfully decodes a reference signal, the user equipment may not need to repeat channel estimation procedures from scratch when decoding actual data delivered via a data channel because the user equipment can apply information (e.g., measured channel condition values) determined with respect to decoding the control channel or reference signal based on a data-channel/control-channel correlation relationship indicated by a configured, assigned, or determined QCI type, and parameters associated therewith, that relates decoding of the data channel to parameter information determined with respect to decoding the control channel or an SSB signal. However, if MBS data is delegated to be delivered by an NTN node interface while control information exchange is still performed via an TN node interface, wherein the TN node and the NTN node are each associated with a radio channel associated with different radio characteristics, channel correlation between a data channel being facilitated by the NTN node and a control channel being facilitated by the TN node may be lost or disrupted, which may result in suboptimal decoding performance by a user equipment receiving the delegated MBS data traffic flow from the NTN.

According to embodiments disclosed herein, dynamic determination of TN-to-NTN channel compensation may facilitate MBS payload being reliably and efficiently offloaded from a TN node interface to an NTN node interface without disrupting decoding performance at a user equipment (e.g., delegation to, and delivery by, an TN node can be transparent to user equipment devices such that the user equipment may not need to be aware that received MBS payload is actually delivered by an NTN RAN node). According to embodiments disclosed herein, various novel NTN RAN node and TN RAN node signaling and transmission behaviors may facilitate a user equipment making minor adjustments to transmission configuration information, corresponding to an indicated QCI type, to receive delegated MBS data traffic from an NTN node according to terrestrial resources (e.g., scheduled frequency and time resources) that the user equipment may use to receive the data traffic from a terrestrial node before the traffic is delegated for delivery by the NTN node.

According to embodiment disclosed herein, a non-terrestrial radio network node may dynamically determine and feedback, to a terrestrial node, TN-to-NTN channel compensation metrics such that delegating, or offloading, of MBS traffic from the TN node to the NTN node is almost transparent to user equipment receiving the MBS traffic from the terrestrial node. Thus, embodiments disclosed herein may facilitate delegation of data traffic from a terrestrial node to a non-terrestrial node for user equipment that are not designed or configured to be capable of communicating with non-terrestrial nodes according to non-terrestrial resources. According to embodiments disclosed herein, a terrestrial node may dynamically acquire, and potentially filter and aggregate, MBS terrestrial data channel performance metrics (e.g., values measured with respect to receiving MBS traffic by user equipment that correspond to radio channel performance parameters associated with a QCI type) and may share the data channel performance metrics with an identified or determined active NTN node to which MBS data traffic may be delegated. The NTN node may determine, based on the data channel performance metrics shared by the TN node NTN-MBS-data-channel-to-TN-MBS-control-channel compensation, or offset/adjustments values, that may be applied, by user equipment, to the terrestrial data channel performance metrics. According to embodiment disclosed herein, user equipment devices, including NTN-non-capable devices, may be enabled to transparently resume MBS sessions, comprising delegated traffic associated with an MBS session that the user equipment have been conducting via a terrestrial node, via an NTN interface node interface without decoding performance with respect to the delegated traffic being degraded. According to embodiments disclosed herein, user equipment may use various channel compensation metrics, corresponding to a QCI type indication, depending on whether MBS traffic is received via a terrestrial interface or a non-terrestrial interface.

According to conventional techniques, a RAN node only determines correlation of data channel conditions and channel conditions corresponding to a control channel or reference signal channel associated with the RAN according to defined or configured correlation relationships to facilitate decoding of data traffic by a user equipment. Unlike conventional techniques, embodiments disclosed herein may facilitate data delivery being delegated such that a RAN facilitating delivery of delegated traffic facilitate correlation of channel conditions associated with the RAN node to control/reference signal channel(s) associated with another node to facilitate a user equipment receiving data traffic and control traffic from the different RAN nodes associated with the different interface channel conditions.

According to conventional techniques, a serving RAN node only configures user equipment that are connected to, or that have selected, the RAN node to determine decoding of traffic received via a data channel associated with the RAN node with respect to control channel parameter values or reference signal parameter values, determined by the user equipment, that correspond to the RAN node. According to embodiments disclosed herein, to facilitate transparent MBS data delegation from a terrestrial interface to a non-terrestrial interface, a terrestrial RAN node may configure user equipment devices to decode delegated data traffic based on an indicated correlation (e.g., based on a terrestrial QCI type indication) that relates terrestrial data traffic decoding to terrestrial control channel decoding. By applying by a user equipment, offsets, or adjustments, to QCI-type parameter values associated with the terrestrial QCI type, the user equipment may receive and decode delegated data traffic via a data channel associated with an NTN node based on adjustments, or offsets, to measured parameter values that apply with respect to decoding control channel traffic received from a TN node, thus facilitating inter-node differential channel correlation based on offsets, or adjustments, that may be referred to as inter-node differential channel correlation information.

According to conventional techniques, channel correlation for decoding is same-node inter-channel, (e.g., inter-channel correlation applies to decoding of different channels corresponding to the same RAN node). For example, according to conventional techniques, user equipment may decode a signal A associated with a first RAN node and expect all or part of decoding information pertaining to decoding of the channel corresponding to delivery of signal A to be highly correlated to a signal B delivered via a different channel associated with the first RAN node. According to embodiments disclosed herein, inter-node inter-channel correlation may facilitate channel conditions corresponding to delivery of a signal A by a first RAN node being correlated with channel conditions corresponding to delivery of a signal B by a second RAN node.

According to conventional techniques, a user equipment may adopt a semi-static channel correlation behavior for decoding of data channel and control channel or reference signal channels corresponding to the same RAN node. According to embodiments disclosed herein, user equipment may adaptively with respect to time, adopt different relative channel compensation metrics (e.g., offset/adjustment values to be applied to terrestrial parameter values or non-terrestrial parameter values) depending whether some or all delegated traffic is received via an NTN interface, and depending on whether the user equipment is non-terrestrial-capable.

### Non-Terrestrial Multicast Broadcast Service Delivery

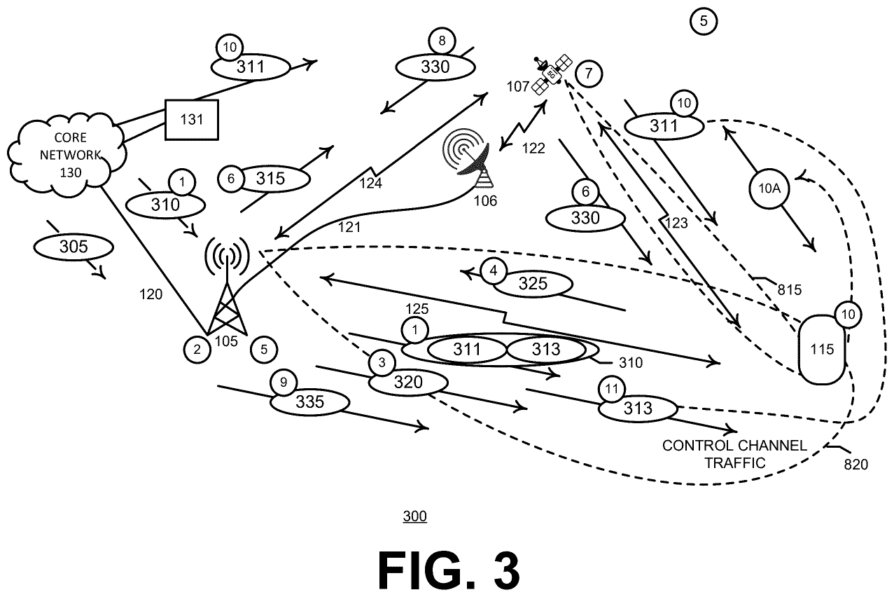

Turning now to FIG. 3, the figure illustrates an environment 300 with a user equipment 115 having selected TN node 105 as a serving node. At act 1, UE 115 may receive terrestrial traffic 310, for example traffic associated with a multicast broadcast service (“MBS”) communication session. Traffic 310 may comprise data traffic 311 delivered via terrestrial data channel terrestrial resources and control traffic 313 delivered via terrestrial control channel resources. UE 115 may be within coverage range 815 of non-terrestrial radio network node 107. At act 2, terrestrial network node 105 may determine to delegate at least a portion of traffic 310 to be delivered via non-terrestrial radio network node 107. The determining to delegate at least a portion of traffic 310 may be based on a request 305 received from a network element of core network 130 or from shared network element 131. At act 6, based on receiving request 305, TN node may direct delegated traffic delivery request 315 to NTN node 107. Delegated traffic delivery request 315 may be indicative of a request that non-terrestrial radio network node 107 facilitate delivering of traffic 310, either all or a portion thereof, with respect to user equipment 115.

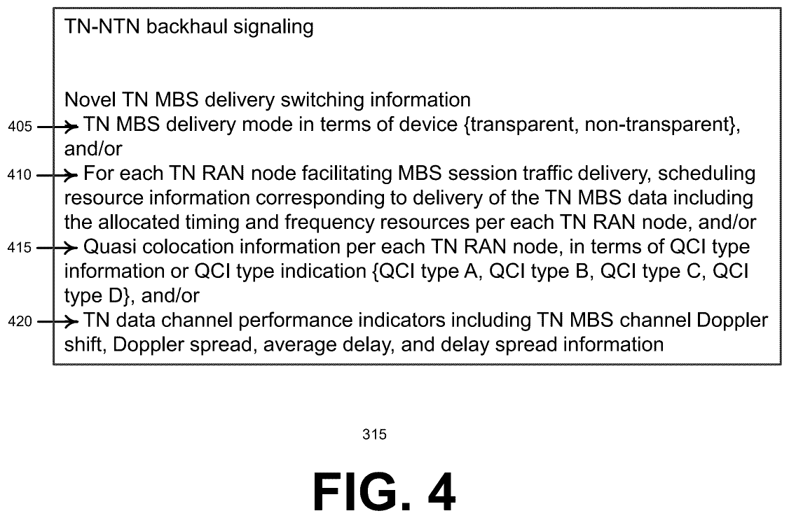

As shown in FIG. 4, request 315 may comprise a TN MBS delivery mode indication, shown in field 405, indicative of transparent delivery or non-transparent delivery, by NTN node 107, of traffic, corresponding to traffic 310, that has been determined to be delegated for delivery to UE via NTN node 107. In field 410, request 315 may comprise, with respect to each of at least one TN node 105 facilitating delivery of MBS traffic 310 to user equipment, which may comprise more than one user equipment, resource scheduling information used by the at least one TN node to facilitate delivery of data traffic associated with traffic 310. In field 415, request 315 may comprise quasi colocation information (“QCI”) with respect to each TN node 105 facilitating delivery of traffic to UE(s) 115. The QCI information may comprise at least one QCI type indication (e.g., an indication of QCI type A, QCI type B, QCI type C, or QCI type D), indicative of correspondence of data decoding information usable to decode data channel data traffic corresponding to traffic 310 with respect to decoding information usable to decode a channel associated with synchronization signal block signals (“SSB”s) corresponding to at least one TN node 105 and/or downlink control channel traffic associated with of at least one TN RAN node 105. Request 315 may comprise, in field 420, at least one terrestrial data channel performance indicator, which may be referred to as a terrestrial radio channel performance parameter value, that may be indicative of at least one terrestrial multicast broadcast service channel doppler shift value, at least one doppler spread value, at least one average delay value, or at least one delay spread value. Terrestrial radio channel performance parameter values may correspond to delivery of traffic 310 by TN node 105 to UE 115.

Delivery of MBS data payload 311 may be delegated from TN node 105 to NTN node 107 while basic MBS control channel message traffic 313 may continue to be facilitated by TN node 105 (e.g., MBS control plane is still active with respect to an TN interface at TN node 105). Information indicated in field 405 of request 315 may be indicative of a mode according to which NTN node 107 is to facilitate delivery of MBS data traffic associated with traffic 310 and whether the delegation of the data payload traffic should be transparent or non-transparent to UE 115. A transparent delivery mode indication may be indicative that UE devices 115 is/are to resume receiving MBS traffic associated with traffic 310 without making a change to facilitate receiving the traffic (e.g., without retuning receiving circuitry or adjusting configuration settings to receive the delegated traffic according to non-terrestrial resources). A non-transparent delivery mode indication may be indicative that UE device 115 is/are to resume receiving MBS traffic associated with traffic 310 after making a change to receive the traffic (e.g., after establishing a connection with NTN node 107 and retuning receiving circuitry or configuration to receive the delegated traffic according to non-terrestrial resources). Non-transparent mode may be suitable for NTN-capable user equipment that may be designed to receive traffic according to non-terrestrial frequency resources and transparent mode may be suitable for user equipment that are not designed to receive, or are otherwise incapable of receiving, traffic according to non-terrestrial resources.

Thus, transparent MBS delivery mode may facilitate UE 115 resuming receiving of delegated MBS data payload 311 associated with traffic 310 from NTN node 107 via the same terrestrial downlink resources as the UE receives traffic 310 from TN node 105 (e.g., the sate terrestrial timing or frequency resources). Therefore, request 315 may comprise, in field 410, information indicative of scheduled terrestrial downlink resources used to deliver traffic 310 to UE 115 via TN node 105. However, due to a non-terrestrial-incapable user equipment expecting to decode data traffic via a data channel facilitated by TN node 105 channel according to a certain relationship to TN control channel signals and/or TN node reference signals, indication of QCI type in field 415 of request 315 may facilitate the relationship being maintained, despite delegated MBS data channel traffic 311 and associated control channel signaling traffic 313 being transmitted by NTN node 107 and TN node 105, respectively. Accordingly, delegating data traffic 311 associated with traffic 310 according to a transparent mode may facilitate a non-terrestrial-incapable user equipment receiving the delegated data traffic from NTN node 107 and control channel traffic corresponding to the delegated traffic via TN node 105 without the user equipment establishing a connection with the NTN node and without the user equipment being notified of delegation of the data traffic (e.g., the delegation is transparent to the user equipment.)

To facilitate delegated data traffic and associated control channel traffic being delivered from NTN node 107 and TN node 105, respectively, channel compensation may be applied to minimize degradation of decoding performance experienced by UE 115. A QCI type indicated in field 415 of request 315 may facilitate NTN RAN node 107 obtaining a relationship between data traffic decoding information and control traffic decoding information usable by UE 115 to decode data traffic 311 and control traffic 313, respectively. Information indicated in field 420 may be indicative of at least one terrestrial channel radio performance parameter with respect to link(s) 125 (e.g., TN channel average delay, doppler spread, etc.). Using information indicated in field 420, NTN RAN node 107 may determine a difference with respect to at least one radio performance parameter experienced by UE 115 receiving traffic from TN node 105 and NTN node 107. Based on at least one determined difference with respect to at least one radio performance parameter experienced by UE 115 in receiving traffic from TN node 105 and NTN 107, NTN node 107, responsive to request 315, may determine at least one channel compensation value, or at least one offset/adjustment value, to compensate for the at least one determined difference such that receiving, by UE 115, of delegated data traffic 311 via NTN node 107 can be transparent to the UE.

Responsive to receiving at least one request 315, comprising an indication in field 405 indicative of transparent delivery of delegated data traffic 311, corresponding to each of one or more TN RAN node(s) 105 that may be facilitating delivery of MBS traffic associated with traffic 310, at act 7 shown in FIG. 3 NTN RAN node 107 may calculate or determine, based on information indicated in request 315, at least one QCI parameter difference offset/adjustment value (e.g., at least one parameter value associated with a QCI type indicated in field 415), which may be referred to as at least one non-terrestrial radio channel performance parameter adjustment value, to account for at least one difference in delivering of payload by the NTN node as compared to delivery of traffic by TN node 105. NTN node 107 may determine the at least one difference in reference to information, indicated in field 410, corresponding to a user equipment decoding an SSB signal broadcast by TN node 105 or decoding control channel traffic transmitted by TH node 105 and associated with traffic session 310. The at least one difference determined by NTN node 107 may comprise at least one of: a QCI difference offset with respect to Doppler shift, at least one QCI difference offset with respect to Doppler spread, at least one QCI difference offset with respect to average delay, or at least one QCI difference offset with respect to delay spread. NTN node 107 may determine a difference offset by calculating a difference between a value corresponding to a radio condition/performance value indication corresponding to traffic being delivered via the NTN RAN node and a value corresponding to the radio condition/performance value indication corresponding to traffic being delivered via TN RAN node 105 indicated in field 420 (e.g., a difference offset of average delay may equal an NTN data channel average delay minus TN data channel average delay), wherein a radio condition/performance value indication, corresponding to traffic delivery to UE 115 by TN node 105, may be received by the TN node 105 via a message 325 and may be reported by the TN node to the NTN node via field 420 in request 315.

If request 315 indicates in field 405 non-transparent delivery of delegated data traffic, NTN RAN may determine at act 7 a NTN QCI type for MBS payload delivery via NTN interface link(s), wherein the NTN node may relate channel decoding of the target MBS data channel that may facilitate delegated delivery of data traffic 311 to SSB signal(s) broadcast by the NTN node or to an NTN downlink control channel. Thus, if non-transparent mode is indicated in request 315, NTN RAN node 107 does not need to calculate and determine channel compensation/offset values. Accordingly, non-terrestrial-capable user equipment that are to receive delegated data traffic 311 via NTN node 107 may transition to an NTN interface corresponding to NTN node 107 and delivery of data channel traffic 311 and control channel 313 may be facilitated via the NTN interface. Therefore, according to a non-transparent indication in field 405 of request 315, NTN node 107 may deliver, to non-terrestrial-capable user equipment, data traffic 311, that is delegated for delivery via NTN node 107, and associated control traffic 313.

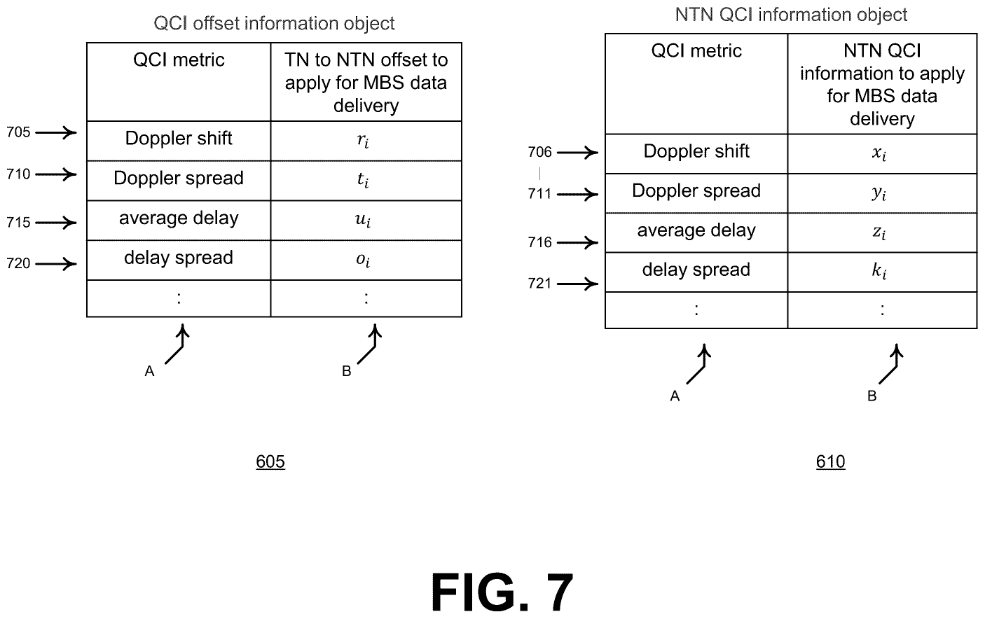

Responsive to request 315, at act 8, shown in FIG. 3, NTN RAN node 107 may direct toward TN node 105 via backhaul interface links at least one non-terrestrial radio channel performance parameter adjustment message 330 comprising at least one non-terrestrial radio channel performance parameter adjustment value determined at act 7. Message 330 may comprise a QCI offset information object 605, shown in FIG. 7, that may comprise the at least one non-terrestrial radio channel performance parameter adjustment value determined at act 7, usable to facilitate delivery of data traffic according to a transparent mode indication indicated in field 405 of request 315. Message 330 may comprise a non-terrestrial QCI information object 610, usable to facilitate delivery of data traffic according to a non-transparent mode indication indicated in field 405 of request 315. Message 330 may facilitate TN node 105 re-configuring UE 115, via at least one non-terrestrial radio channel performance parameter adjustment value message 335, to apply channel compensation/offset/adjustment information indicated in object 605 to facilitate delivery of delegated traffic 311 according to a transparent delegation mode. Message 330 may facilitate TN node 105 instructing UE 115 to switch to an NTN interface corresponding to NTN node 107 to use QCI information, or other information, included in message 330 and indicated to UE 115 by information object 610 included in message 335, to receive data traffic 311 and control traffic 313, associated with traffic session 310, via NTN node 107 according to NTN resources and NTN QCI information indicated by object 610 according to a non-transparent delegation mode. At act 9 shown in FIG. 3, TN node 105 may transmit, to UE 115, at least one non-terrestrial radio channel performance parameter adjustment value message 335 comprising the at least one non-terrestrial radio channel performance parameter adjustment value, received from NTN node 107 via message 330, to be usable by UE to receive, from NTN node 107, delegated data traffic 311 according to a transparent mode indicated in field 410 of request 315.

As show in in FIG. 7, object 605 may comprise at least one of: in field 705B a terrestrial-to-non-terrestrial MBS data channel doppler shift value corresponding to a doppler shift parameter indicated in field 705A; in field 710B a terrestrial-to-non-terrestrial MBS data channel doppler spread value corresponding to a channel doppler spread parameter indicated in field 710A; in field 715B a terrestrial-to-non-terrestrial MBS data channel average delay value corresponding to average delay parameter indicted in field 715A; or in field 720B a terrestrial-to-non-terrestrial MBS channel delay spread value corresponding to a delay spread value parameter indicated in field 720A. Object 610 may comprise at least one of: in field 7065B a non-terrestrial MBS data channel doppler shift value corresponding to a doppler shift parameter indicated in field 706A; in field 711B a non-terrestrial MBS data channel doppler spread value corresponding to a channel doppler spread parameter indicated in field 711A; in field 716B a non-terrestrial MBS data channel average delay value corresponding to average delay parameter indicted in field 716A; or in field 721B a non-terrestrial MBS channel delay spread value corresponding to a delay spread value parameter indicated in field 721A.

At act 10, NTN RAN node 107 may receive delegated data traffic payload 311 from at least one TN RAN node 105, or from a shared network entity 131, to be delivered to UE 115. If transparent mode is indicated in field 405 of request 315, user equipment 115 may experience little, or no, disruption in receiving data traffic 311 because NTN node 107 may apply an offset determined at act 7 so that any increase in delay in transmitting traffic 311 by NTN node 107 as compared to transmitting traffic 311 by TNT node 105 is accounted for by the NTN node. In an embodiment, user equipment 115 may apply an offset received via message 335 to facilitate receiving data traffic 311 from NTN node 107 at act 10 according to a transparent delegation mode. If transparent mode is indicated in field 405 of request 315, user equipment 115 may continue to receive control channel traffic 313 at act 11 from TN node 105. If non-transparent mode is indicated in field 405 of request 315, user equipment 115 may perform RRC connection establishment procedures at act 10A with NTN node 107 and may receive data traffic 311 as well as control traffic 313 from NTN node 107 via a connection established at act 10A. If non-transparent mode is indicated in field 405 of request 315, user equipment 115 may flush information corresponding to delivery of traffic 310 with respect to TN node 105.

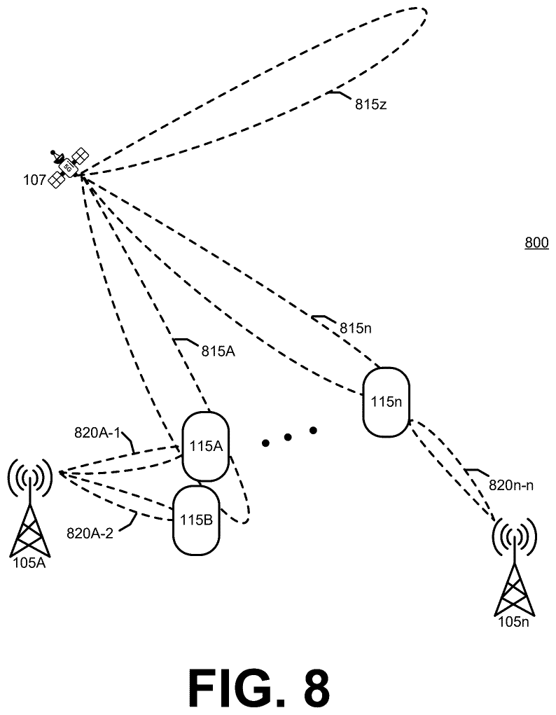

As shown in FIG. 8, NTN RAN node 107 may determine at least one non-terrestrial downlink beam 815 that may correspond to a geographic area coverage footprint that may overlap with a geographic area coverage footprint associated with a terrestrial downlink beam 820 corresponding to TN node 105 that requested, via request 315, delegation of delivery of traffic associated with traffic flow(s) 310. As shown in FIG. 8, user equipment 115A and user equipment 115B may be located in locations that correspond to terrestrial beams 820A-1 and 820A-2, respectively, that are associated with TN node 105A. User equipment 115n may be in a location that corresponds to terrestrial beam 820n-n. Accordingly, to accommodate delegation of traffic, corresponding to an MBS traffic session, currently being facilitated by TN nodes 105A and 105n, NTN node 107 may determine to facilitate delivery of delegated traffic corresponding to the MBS session to UEs 115A-115n via NTN beams 815A and 815n, but not via beam 815z because a geographic coverage footprint corresponding to beam 815z does not overlap with a geographic coverage footprint corresponding to at least one beam 820, as shown in FIG. 8. It will be appreciated that because a geographic area coverage footprint corresponding to a non-terrestrial network node is large compared to a geographic area coverage footprint corresponding to a terrestrial network node, NTN node 107 may determine to facilitate delivery of delegated MBS traffic to user equipment 115 via only one non terrestrial downlink beam, but multiple non-terrestrial downlink beams are illustrated in FIG. 8 to illustrate that more than one non-terrestrial downlink beam may be used to facilitate delivery of delegated MBS when traffic corresponding to an MBS traffic session is delivered to many user equipment located across a large geographic area.

If transparent mode is indicated in field 405 of request 315, NTN node 107 may transmit (e.g., broadcast or multicast) delegated MBS traffic via one or more determined NTN downlink beams according to terrestrial downlink resources corresponding to each TN RAN node 105A-105 that facilitates delivery of the MBD traffic before delegation of the MBD traffic.

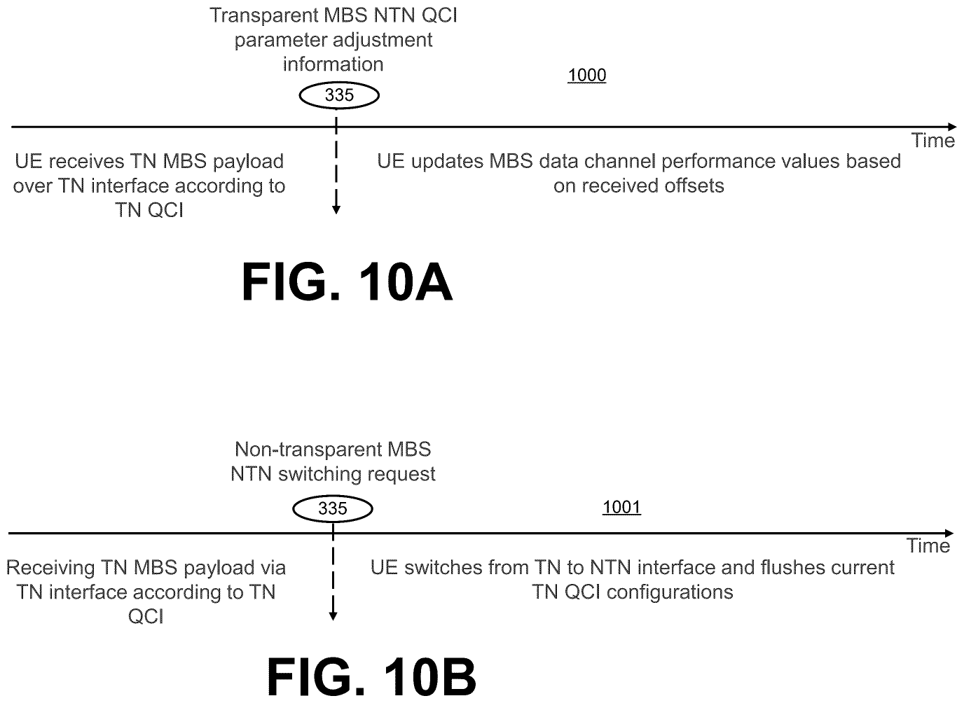

FIGS. 10A and 10B illustrate a timeline of operations from the perspective of user equipment acting in response to a non-terrestrial radio channel performance parameter adjustment value message 335 indicative in field 905 of transparent delegation or indicative in field 910 of non-transparent delegation, respectively.

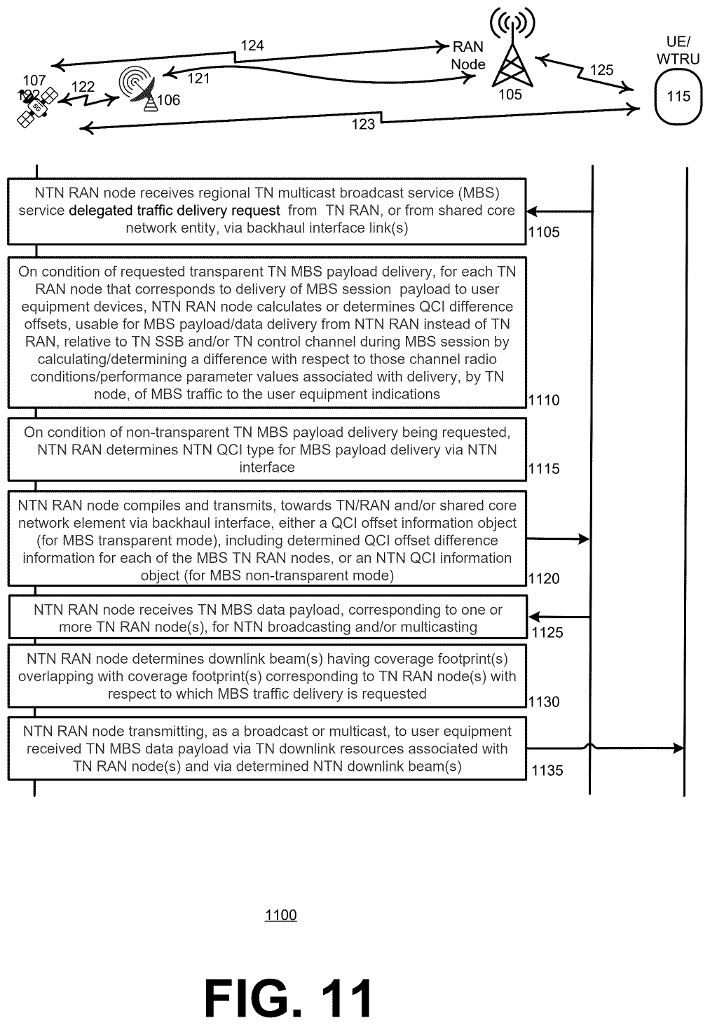

Turning now to FIG. 11, the figure illustrates a timing diagram of an example method 1100. At act 1105, non-terrestrial RAN node/cellular satellite 107 may receive regional TN multicast broadcast service (MBS) service delivery request (e.g., delegated traffic delivery request 315 described in reference to FIG. 3), from TN RAN node 105 and/or shared core network element 131 via backhaul interface link(s). The delegated traffic delivery request may comprise at least one of: a TN MBS delivery mode indication indicative of transparent or non-transparent delegation of MBS data traffic that that TN node is facilitating with respect to UE 115. With respect to at least one TN node 105 facilitating delivery of MBS traffic associated with the MBS session, the delegated traffic delivery request may comprise terrestrial transmission information that may comprise resource scheduling information corresponding to delivery of the TN MBS data, including allocated terrestrial timing and frequency resources with respect to each TN RAN node 105. The delegated traffic delivery request may comprise quasi colocation information corresponding to each TN RAN node 105 in terms of QCI type information indicative of at least one QCI type (e.g., QCI type A, QCI type B, QCI type C, or QCI type D}, wherein a QCI type indicates a relationship of data channel conditions corresponding to the MBS session with respect to channel conditions associated with decoding either synchronization signal block signals transmitted by TN node 105 or decoding downlink control channel traffic corresponding to each respective TN RAN node that may be facilitating delivery of MBS traffic corresponding to the MBS traffic session. The delegated traffic delivery request may comprise terrestrial transmission information that may comprise at least one terrestrial data channel performance indicator, which may be referred to as at least one terrestrial radio channel performance parameter value, indicative of at least one terrestrial MBS channel doppler shift, at least one terrestrial doppler spread, at least one terrestrial average delay, or at least one terrestrial delay spread information.

On condition of transparent TN MBS payload delivery being indicated in field 405 of request 315, for each TN RAN node 105 that may be facilitating delivery of MBS traffic associated with an MBS session to one or more user equipment 115, NTN RAN node 107 may calculate/determine, at act 1110, at least one QCI parameter difference offset usable to facilitate transparent delivery of delegated MBS traffic relative to TN SSB parameter values and/or TN control channel parameter values during a delegation period of MBS traffic associated with MBS session delegated for delivery by NTN node 107 instead of TN node 105. The at least one QCI parameter difference/offset may correspond to a QCI doppler shift, a QCI doppler spread, a QCI average delay, or a QCI delay spread, and may be determined by NTN node 107 by calculating differences with respect to the channel radio conditions/performance parameter values corresponding to delivery of MBS payload via an NTN node 107 NTN RAN node versus delivery of the MBS traffic payload when delivered via a TN node 105 (e.g., a difference offset of average delay may equal an NTN data channel average delay minus TN data channel average delay corresponding to average delay values received from each of one or more TN nodes).

At act 1115, on condition of a delegated traffic delivery request being indicative of non-transparent TN MBS payload delivery, NTN RAN node 107 may determine an NTN QCI type for MBS payload delivery via an NTN interface corresponding to the NTN node, wherein the NTN QCI type is indicative of a relationship of information usable to decode the target MBS data channel when delivered via the NT interface with respect to decoding of either NTN synchronization signal blocks corresponding to the NTN node or with respect to an NTN downlink control channel corresponding to the NTN node.

At act 1120, NTN RAN node may compile and direct toward TN RAN node 105, or shared network element 131, via backhaul interface link(s), either a QCI offset information object (e.g., object 605), comprising information determined at act 1110, to facilitate transparent delegation of delivery of MBS traffic, including determined QCI offset difference information with respect to each of TN RAN node facilitating transparent delegation of delivery of the MBS traffic to NTN node 107, or an NTN QCI information object (e.g., object 610), that may comprise information determined at act 1115, to facilitate non-transparent delegation of delivery of MBS traffic.

At act 1125, NTN RAN node may receive terrestrial MBS data payload from, or with respect to, each at least one TN RAN node 105 that may facilitate delivery of MBS traffic to one or more user equipment 115 for delegated delivery thereto. At act 1130, NTN RAN node 107 may determine one or more non-terrestrial downlink beams corresponding to the NTN node having non-terrestrial geographic coverage that overlaps with terrestrial geographic coverage corresponding to one or more TN RAN nodes from which a request 315 may have been received at act 1105. At act 1135, for delivery of MBS traffic with respect to which transparent delegation mode is indicated via a request 315 received at act 1105, NTN RAN node 107 may transmit, via broadcast or multicast transmission mode, terrestrial MBS data payload, received at act 1125, according to terrestrial downlink resources via one or more NTN downlink beams determined at act 1130.

### Terrestrial Multicast Broadcast Service Delegation

As shown by FIG. 3, terrestrial node 105 may receive a multicast broadcast service (MBS) delegation request 305, from an entity corresponding to core network 130 or shared network element 313 via backhaul interface link(s). Request 305 may comprise a delivery delegation mode indication indicative of transparent mode or non-transparent mode. TN RAN 105 node may determine and schedule time or frequency resources to facilitate delivery of MBS traffic 310 and corresponding quasi colocation information QCI corresponding to terrestrial delivery of the MBS traffic with respect to UE 115. A QCI may be indicative of a relationship of data channel conditions as compared to channel conditions, or performance parameters corresponding thereto, perceived by UE 115 with respect to terrestrial delivery of synchronization signal block signals and/or terrestrial delivery of downlink control channel traffic.

TN RAN node 105 may determine at least one NTN RAN node 107, corresponding to at least one coverage footprint(s) overlapping at least one terrestrial coverage footprint corresponding to the TN node, to which delivery of data traffic 311 may be delegated. On condition of a configured transparent TN MBS delivery mode being indicated in message 305, at act 3 terrestrial radio network node 105 may transmit to at least one user equipment 115 MBS channel performance reporting request 320, which may be referred to as a terrestrial radio channel performance parameter value report request, and which may comprise a request that the at least one user equipment direct at least one terrestrial radio channel performance parameter value report to the terrestrial radio network node. Request 320 may be transmitted to user equipment that are actively receiving MBS traffic 310 according to a configured groupcast or broadcast downlink control channel message. At act 4, TN RAN node 105 may receive at act 4 from the at least one user equipment MBS channel performance report 325, which may comprise a terrestrial radio channel performance parameter value indication indicative of at least one terrestrial radio channel performance parameter value corresponding to receiving of the terrestrial traffic 310 by the at least one user equipment. The at least one terrestrial radio channel performance parameter value may be indicative of at least one parameter corresponding to traffic flow 310, such as, for example, at least one of: an MBS channel doppler shift, an MBS channel delay spread, an MBS channel average delay, or an MBS channel doppler spread.

At act 5, TN RAN node 105 may calculate and select overall MBS channel performance indications in terms of an average, a worst, or a specially filtered received-signal MBS channel performance value. At act 6, TN RAN node 105 may transmit, to at least one NTN RAN node 105 determined to correspond to a geographic coverage footprint that overlaps with a geographical coverage footprint corresponding to the TN node, delegated traffic delivery request 315. Information indicated in field 405 of request 315 may be indicative of a mode of MBS delegated data delivery via an NTN interface, and whether delegation of traffic is to be transparent or non-transparent to at least one user equipment receiving the MBS traffic to be delegated. A transparent mode indication may be indicative that a user equipment, that is to receive delegated MBS traffic via NTN node 107 to which request is transmitted, is to receive the delegated traffic without ‘noticing’ that the MBS traffic is delegated and is being transmitted via an NTN node. Thus, delivery of delegated MBS traffic based on an indication in field 405 of transparent mode may facilitate delivery of the delegated traffic to a non-terrestrial-incapable user equipment device. If transparent mode is indicated, user equipment may resume receiving of delegated traffic 311 at act 10 from NTN node 107 according to the same TN downlink resources, indicated in field 410, that the user equipment uses to receive, at act 1 from TN node 105, traffic 310 before traffic 311 is delegated. To facilitate user equipment expectation(s) to receive data traffic 311 according to a decoding relationship with respect to receiving control traffic 313 or reference signals from TN node 105, the decoding relationship may be maintained by NTN node 107 based on a QCI type indicated in field 415. Radio performance values indicated in field 420 may facilitate NTN RAN node 107 determining at least one difference value based on at least one value indicated in field 420 and at least one corresponding parameter value associated with delivery of traffic to UE 115 via NTN node 107. The difference(s) determined by NTN node 107 may be referred to as parameter offset values, may be received by TN node 105 in message 330 from NTN node 107, and may be forwarded to UE 115 via message 335 for use by the UE to receive delegated data traffic 311, with respect to receiving of control channel traffic 313, from NTN node 107. Parameter offset values may be based on, or may correspond to, a QCI type according to which the UE receives both data traffic 311 and control channel 313 from TN node 105 at act 1.

Responsive to transmitting request 315, TN RAN node may receive, at act 8 from determined NTN RAN nodes 107, message 330 comprising either QCI offset information object 605 for traffic delegation transparent mode or information object 610 for non-transparent mode indicated in field 405 in request 315. As shown in FIG. 7, information object 605 may comprise QCI offset/difference values determined by NTN node 107 with respect to terrestrial parameter values indicated in field 420 of request 315. Information object 610 may comprise NTN QCI information object usable for delivery of delegated data traffic 311 according to non-transparent mode.

TN RAN node 105 may transmit non-terrestrial radio channel performance parameter adjustment value report message 335 to user equipment 115 as a terrestrial downlink control information message comprising MBS payload delivery configuration information such as, for example, one or more combinations of at least one of: QCI offset information for transparent TN MBS delivery via NTN interface, NTN switching request including an identifier associated with target NTN RAN 107 usable for non-transparent delivery of delegated terrestrial MBS traffic by NTN node 107 via NTN interface resources and link(s) 123, or NTN QCI type information/indication corresponding to target NTN RAN node 107 usable for usable for non-transparent delivery of delegated terrestrial MBS traffic by NTN node 107 via NTN interface resources and link(s) 123.

On condition of transparent MBS delivery via NTN interface link(s) 123 being indicated by request 315, TN RAN node 105 may resume transmissions of TN downlink control channel traffic 313, SSB signals, or MBS reference signals to user equipment during an activated MBS session delegation period. On condition of non-transparent MBS delivery by NT node 107 via NTN interface link(s) 123 and via non-terrestrial resources, TN RAN node 105 may halt operation of TN downlink control channel channels, SSB signals, or MBS reference signals with respect to active MBS devices during an active MBS delegation period.

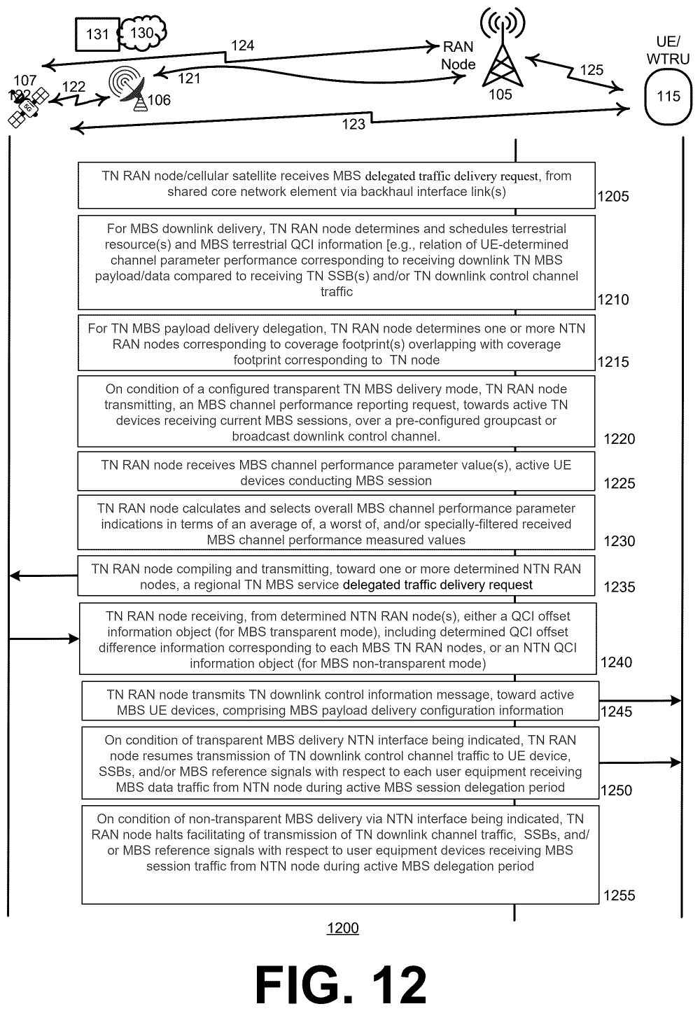

Turning now to FIG. 12, the figure illustrates a timing diagram of an embodiment method 1200. At act 1205, terrestrial RAN node 105 may receive a multicast broadcast service delegation request message, directed to the terrestrial RAN node by an element of core network 130 or by shared core network element 131, via backhaul interface link(s). The request message received at act 1205 may comprise a delegated traffic delivery mode indication indicative of a traffic delegation mode to be implemented with respect to delegation of delivery of traffic corresponding to an MBS traffic session being conducted by the terrestrial RAN node with at least one user equipment 115. A delegation mode indication may be indicative of a transparent traffic delegation mode or a non-transparent traffic delegation mode. At act 1210, TN RAN node 105 may determine and schedule terrestrial resources to facilitate delivery, by the TN RAN node, of downlink MBS corresponding to the communication session and the TN RAN node may determine terrestrial quasi colocation information (e.g., relation of channel conditions perceived by a UE 115, or measured performance values corresponding to receiving of downlink MBS payload/data, to received terrestrial synchronization signal blocks signals and/or TN downlink control channels message transmission corresponding to the TN RAN node). At act 1215, TN RAN node 105 may determine one or more NTN RAN nodes 107, corresponding to one or more geographic coverage areas that overlap with terrestrial coverage areas associated with the TN RAN node used to facilitate delivery of terrestrial MBS payload to user equipment that is to be delegated, based on the request received at act 1205. On condition of a request received at act 1205 being indicative of transparent TN MBS delivery mode, at act 1220 TN RAN node 105 may transmit an MBS channel performance reporting request (e.g., request 320 described in reference to FIG. 3) toward active UE devices 115 receiving MBS traffic corresponding to session 310. Message 320 may be transmitted to user equipment 115 via a pre-configured groupcast or broadcast downlink control channel corresponding to the user equipment. At act 1225, TN RAN node 105 may receive MBS channel performance parameter values, via terrestrial radio channel performance parameter value report 325 described in reference to FIG. 3, from active UE devices 115. Report 325 may comprise an MBS channel doppler shift value determined by user equipment that may receive request message 320, an MBS channel delay spread value determined by user equipment that may receive request message 320, an MBS channel average delay determined by user equipment that may receive request message 320, or an MBS channel doppler spread value determined by the user equipment that may receive request message 320.

At act 1230, TN RAN node may determine overall MBS channel performance indications, for example an average of at least one measured value corresponding to a parameter received in at least one report 325, a worst of at least one measured value corresponding to a parameter received in at least one report 325, or specially-filtered MBS channel performance sample values corresponding to a parameter received in at least one report 325. At act 1235, TN RAN node 105 may compile and transmit, toward one or more NTN RAN nodes 107 determined at act 1215, a regional TN MBS service delivery request, (e.g., delegated traffic delivery request 315 described in reference to FIGS. 3 and 4) that may comprise at least one of the following information elements: a TN MBS delivery mode indication indicative of a transparent traffic delivery delegation mode or a non-transparent traffic delivery mode; scheduled resource information indicative of terrestrial resources scheduled at act 1210, including allocated timing and frequency resources scheduled or allocated at act 1210; at least one quasi colocation information indication node indicative of a QCI type corresponding to delivery of the MBS traffic to user equipment 115 via the scheduled terrestrial resources (e.g., and indication of QCI type A, QCI type B, QCI type C, or QCI type D}, wherein a QCI type is indicative of a relationship of channel decoding of the target MBS data channel traffic with respect to decoding of either the synchronization signal block channel used by TN RAN to broadcast SSBs or with respect to decoding of a downlink control channel corresponding to the TN RAN node; or determined TN data channel performance values indicators, determined with respect to user equipment 115, that may be indicative of a TN MBS channel doppler shift, a doppler spread, as average delay, or a delay spread.

At act 1240, responsive to the delegated traffic delivery request transmitted to NTN node 107 at act 1235, TN RAN node 105 may receive from one or more NTN nodes 107 determined at act 1215 either a QCI offset information object, for example object 605 shown in FIG. 7, usable to facilitate delegation of MBS traffic according to transparent delegation mode, or an NTN QCI information object, for example information object 610 shown in FIG. 7, to facilitate delegation of MBS according to a non-transparent mode. Information object 605 may comprise QCI offset difference information determined by NTN node(s) 107 for each of at least one MBS TN RAN node(s) 105. Information object 610 may comprise non-terrestrial QCI information, determined by NTN node 107, to facilitate delivery of delegated traffic to user equipment 115 without relating decoding of delegated downlink data traffic transmitted by the NTN node to decoding of control channel traffic transmitted by TN node 105.

At act 1245, TN RAN node 105 may transmit a TN downlink control information message to user equipment 115 (e.g., message 335 described in reference to FIG. 3), that may be conducting an MBS communication session (e.g., session 310 described in reference to FIG. 3) comprising MBS payload delivery configuration information that may include one or more of the following information elements: QCI offset information to facilitate the user equipment receiving delegated traffic according to a transparent delivery mode via an NTN interface corresponding to NTN node 107; an NTN switching request including an identifier associated with a target NTN RAN node 107 to facilitate receiving traffic from the NTN node according to a non-transparent MBS delivery mode via an NTN interface corresponding to the NTN RAN node; and/or NTN QCI type information indicative of a QCI type corresponding to an identified target NTN RAN node to facilitate non-transparent MBS traffic delivery via an interface corresponding to NTN node 107.

On condition of message 335 being indicative of a transparent MBS delivery mode via an NTN interface, at act 1250 TN RAN node 107 may resume transmission of TN downlink channels (for delivery of control channel traffic corresponding to delegated MBS data traffic) and/or SSBs and/or MBS reference signals to facilitate for active user equipment receiving delegated MBS traffic during an active MBS session delegation period. Corresponding to an indication in message 335 of non-transparent MBS delegation mode, at act 1255 TN RAN node 105 may halt transmission of TN downlink channels, SSBs, and/or MBS reference signals with respect to non-terrestrial-capable user equipment during an active MBS delegation period.

### Dynamic Device Multicast Broadcast Reception

Returning to description of FIG. 3, UE 115, which may be incapable of communicating with NTN node 107 according to non-terrestrial resources (e.g., the UE may be referred to as a non-terrestrial-incapable user equipment if the user equipment is not capable of communicating with NTN node 107 according to non-terrestrial resources), may receive, at act 3 via TN interface link(s) 125, MBS channel performance reporting request 320, which may be referred to as a terrestrial radio channel performance parameter value report request and which may comprise a request that the user equipment direct at least one terrestrial radio channel performance parameter value report to terrestrial radio network node 105. Request 320 may be transmitted according to a configured groupcast or broadcast downlink control channel resource. Request 320 may facilitate TN RAN node 105, which may be facilitating delivery of traffic 310 with respect to user equipment 115, to determine how much channel compensation may be applied to avoid, or minimize, disrupting decoding performance with respect to transparent delegation of data traffic 311 to be delivered by NTN node 107.

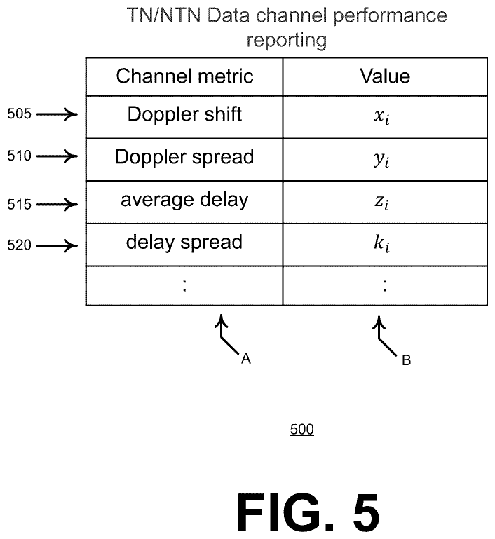

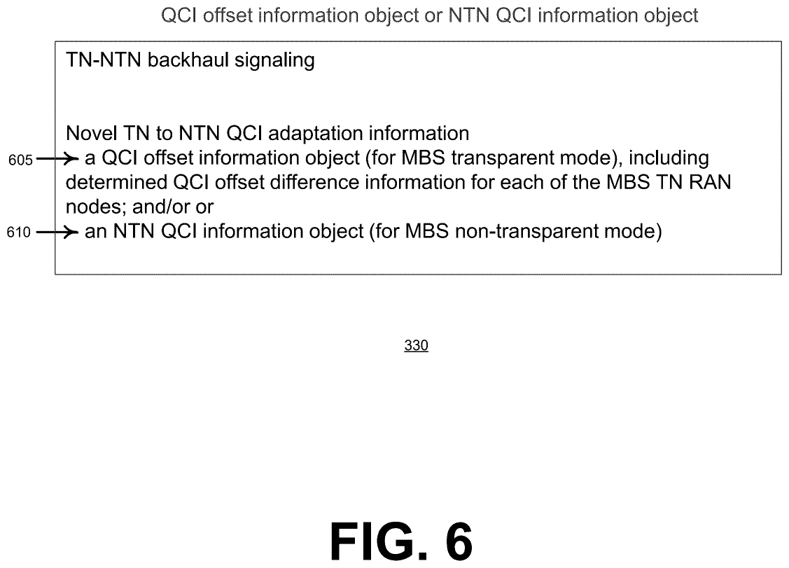

Responsive to request 320, non-terrestrial-incapable UE 115 may determine and transmit, at act 4, at least one terrestrial radio channel performance parameter value report 325. Report 325 may be transmitted toward requesting TN RAN node 105 via uplink TN interface link(s) 125. Report 325 may comprise at least one terrestrial radio channel performance parameter value indication indicative of at least one terrestrial radio channel performance parameter value corresponding to receiving, by user equipment 115 from the terrestrial radio network node 105, traffic 310. The at least one terrestrial radio channel performance parameter value may correspond to a QCI type associated with delivery of communication session traffic 310 between TN RAN node 105 and UE 115. Report 325 may be transmitted according to format 500 shown in FIG. 5 and the at least one terrestrial radio channel performance parameter value may comprise at least one of: in field 505B a terrestrial MBS data channel doppler shift value corresponding to a doppler shift parameter indicated in field 505A; in field 510B a terrestrial MBS channel doppler spread value corresponding to a channel doppler spread parameter indicated in field 510A; in field 515B a terrestrial MBS channel average delay value corresponding to average delay parameter indicted in field 515A; or in field 520B a terrestrial MBS channel delay spread value corresponding to a delay spread value parameter indicated in field 520A.

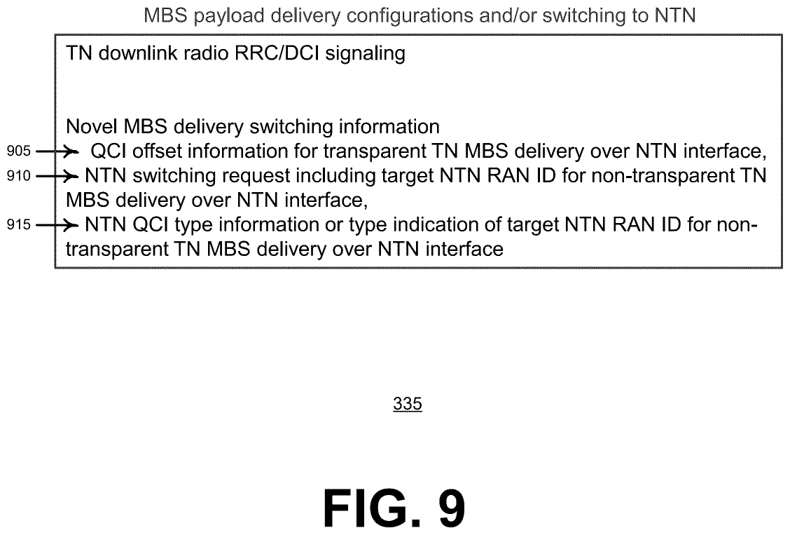

At act 9, user equipment 115 may receive, from TN RAN node 105, MBS payload delivery configuration information message 335, which may be referred to as a radio channel performance parameter adjustment value configuration information message and which may comprise at least one non-terrestrial radio channel performance parameter adjustment value. The at least one non-terrestrial radio channel performance parameter adjustment value may comprise, as shown in FIG. 9, at least one of: in field 905 QCI offset information usable by the user equipment to facilitate transparent delivery of delegated MBS data traffic 311 from NTN node 107 via NTN interface link(s) 123; in field 910 an NTN switching request indication indicative of target NTN RAN node 107, wherein the switching request indication may be usable by the user equipment if the user equipment is non-terrestrial-capable, for non-transparent delivery of traffic 310 via NTN node 107 according to NTN resources; or in field 915 at least one NTN QCI type information indication indicative of at least one NTN QCI type, corresponding to target NTN RAN 107 (e.g., an NTN node identified in field 910), usable by the user equipment if the user equipment is non-terrestrial-capable, for non-transparent delivery of traffic 310 via NTN node 107 according to NTN interface resources.

In an embodiment, on condition of receiving message 335 comprising QCI offset information in field 905 usable for transparent delivery with respect to NTN node 107 of traffic 311, UE 115 may update, or adjust, existing MBS data channel performance parameter value(s) according to the QCI difference offsets received via message 335 by applying the non-terrestrial radio channel performance parameter adjustment value(s) to the terrestrial radio channel performance parameter value(s) to result in at least one adjusted radio channel performance parameter value. UE 105 may temporarily override existing MBS data channel QCI parameter values with the adjusted radio channel performance parameter value(s) to transparently receive, according to the adjusted radio channel performance parameter value(s), the delegated MBS session data traffic 311 from the NTN interface, wherein the delegated data traffic may be received from NTN node 107 according to at least one terrestrial resource, according to which the user equipment may be configured to receive traffic 310 from terrestrial radio network node 105. At act 10, UE 115 may resume receiving of MBS data traffic payload 311 according to scheduled terrestrial resources (e.g., scheduled resources used to receive the terrestrial data traffic at act 1) and decoding of the MBS data traffic payload according to updated offset information indicated in field 905.

In an embodiment, on condition of receiving a message 335 indicative in field 910 that UE 115, which may be a non-terrestrial-capable user equipment, is to switch to receiving of traffic 310 according to non-transparent delivery via NTN interface link(s) 123, responsive to a switching request included in field 910, the user equipment may switch from receiving traffic 310 via interface link(s) 125 to receiving the traffic via NTN interface link(s) 123 and may flush current terrestrial QCI configuration information. UE 115 may detect or decode non-terrestrial reference signals broadcast by NTN node 107. UE 115 may determine NTN-specific channel performance values with respect to NTN node 107, comprising NTN MBS data channel doppler spread, delay spread, MBS channel average delay, and MBS channel doppler spread. UE 115 may non-transparently receive or decode MBS data payload via NTN interface link(s) 123 according to non-terrestrial resources scheduled to facilitate non-terrestrial delivery of MBS traffic 310. To facilitate non-transparent delivery of traffic 310, UE 115 may adopt NTN QCI type information indicated in field 915 based on non-terrestrial channel performance parameters that may be determined by UE 115 with respect to NTN node 107.

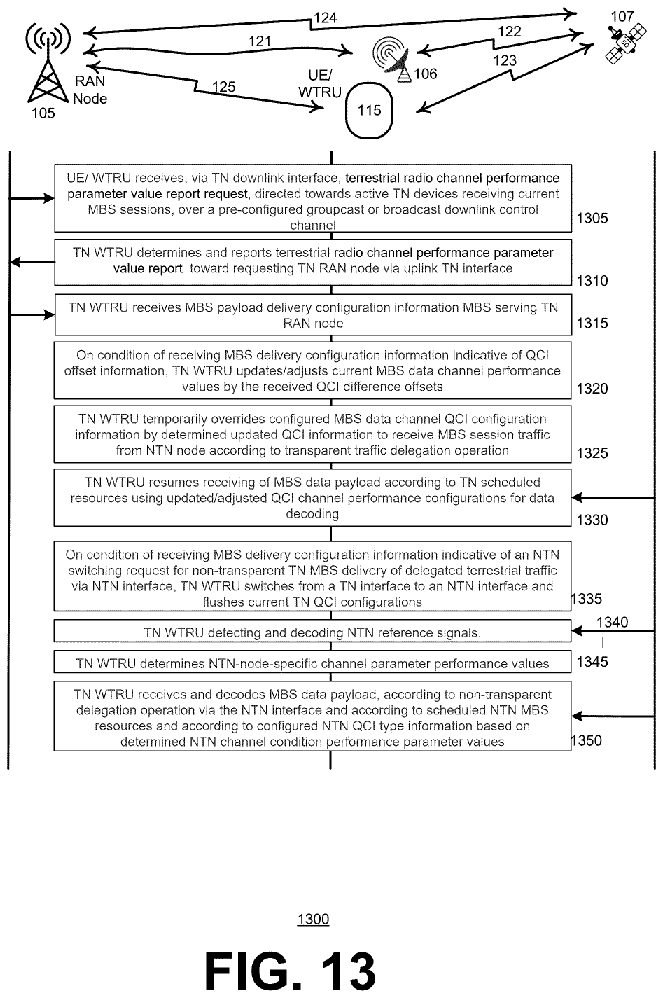

Turning now to FIG. 13, the figure illustrates a timing diagram of an example method embodiment 1300. At act 1305, user equipment 115 may receive, via TN downlink interface link(s) 125, an MBS channel performance reporting request, which may be referred to as a terrestrial radio channel performance parameter value report request, directed toward active TN devices receiving traffic associated with a current MBS session, via a configured groupcast or broadcast downlink control channel. At act 1310, responsive to the terrestrial radio channel performance parameter value report request, UE 115 may determine and transmit, to terrestrial radio network node 105 that requested the MBS channel performance report, at least one terrestrial radio channel performance parameter value report comprising at 105, least one terrestrial radio channel performance parameter value indication indicative of at least one terrestrial radio channel performance parameter value corresponding to receiving, by the user equipment from the terrestrial radio network node, traffic associated with at least one terrestrial traffic flow. The at least one terrestrial radio channel performance parameter value may comprise at least one of: a TN MBS data channel doppler shift, a TN MBS channel delay spread, a TN MBS channel average delay, or a TN MBS channel doppler spread. At act 1315, TN UE/WTRU 115 may receive MBS payload delivery configuration information from MBS serving TN RAN node 105. The received configuration information may comprise any combinations of the following information elements: quasi colocation information offset information for transparent TN MBS delivery over NTN interface, an NTN switching request including target NTN RAN identifier corresponding to NTN node 107, usable to facilitate non-transparent TN MBS delivery via NTN interface link(s) 123, or at least one NTN QCI type information indication indicative of at least one QCI type indication associated with target NTN RAN node 107 usable to facilitate for non-transparent TN MBS delivery over NTN interface. On condition of receiving MBS delivery configuration information indicative of QCI offset information usable for transparent TN MBS delivery via NTN interface, TN UE/WTRU 115 may update, or adjust, one or more current MBS data channel performance value(s) by received QCI difference offset values. At act 1320, TN UE/WTRU 115 may temporarily override configured MBS data channel QCI configuration information with determined adjusted/updated QCI information to transparently receive MBS session data traffic from NTN node 107. At act 1325, TN UE/WTRU may resume receiving MBS data payload according to terrestrial resources scheduled to facilitate receiving, by the UE from RAN node 105, the MBS session traffic according to adjusted/updated QCI channel performance parameter information usable for data traffic decoding. At act 1330, on condition of receiving MBS delivery configuration information indicative of an NTN switching request to facilitate non-transparent terrestrial MBS traffic delivery via NTN interface links 123, UE/WTRU 115 may switch from a TN interface corresponding to TN node 105 to an NTN interface corresponding to NTN node 107 and flush current TN QCI configuration information. At act 1335, UE/WTRU 115 may detect and decode NTN reference signals. At act 1340, UE/WTRU may calculate NTN-specific channel performance values including NTN MBS data channel doppler spread, delay spread, MBS channel average delay, or MBS channel doppler spread. At act 1350, UE/WTRU may receive and decode MBS data payload, according to non-transparent operation, via the NTN interface connected with at act 1330, via scheduled NTN scheduled resources and according to configured NTN QCI type information with respect to determined/measured NTN channel performance parameter values.

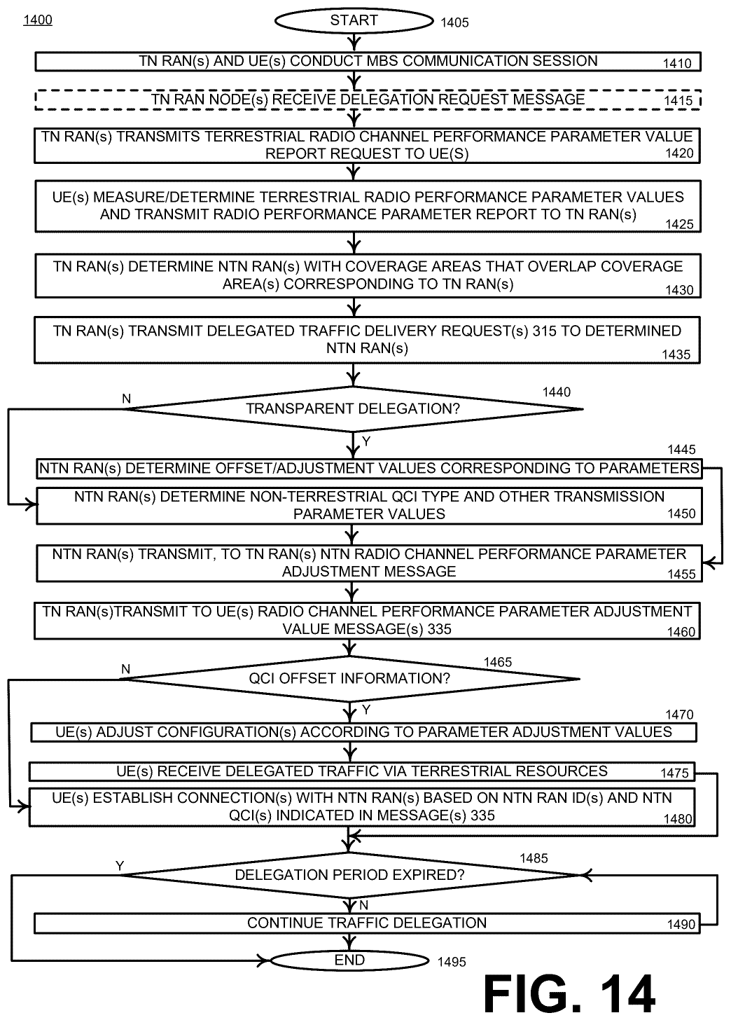

Turning now to FIG. 14, the figure illustrates a flow diagram of an example method 1400. Method 1400 begins at act 1405. At act 1410, at least one terrestrial radio network node and at least one user equipment may establish, or conduct, a multicast broadcast service communication session comprising data channel traffic and control channel traffic. At act 1415, at least one of the at least one terrestrial radio network node may receive a delegation request message, such as, for example, request message 305 described in reference to FIG. 3, indicative that the terrestrial radio network node is to delegate at least a portion of the multicast broadcast service traffic to result in delegated traffic. A request received at act 1415 may be indicative that the delegated traffic is to comprise at least data channel traffic corresponding to the multicast broadcast service communication session. Block 1415 is illustrated in dashed lines in FIG. 14 to indicate that receiving a delegation request message instructing at least one terrestrial radio network node to delegate traffic is an embodiment. In another embodiment, a terrestrial radio network node may determine to delegate traffic without having received a delegation request message. A delegation request message received at act 1415 may be received from a network element of a core network, for example core network 130 shown in FIG. 1, or a from shared core network element, for example network element 131 shown in FIG. 1. A network element may determine to direct a delegation request message to a terrestrial radio network node based on multiple terrestrial radio network nodes facilitating delivery of the same data traffic to multiple user equipment, wherein the multiple terrestrial radio network nodes may be unaware that other terrestrial radio network nodes are facilitating delivery of the same data traffic. A delegation request message received at act 1415 may be indicative that a terrestrial radio network node is to delegate delivery of data traffic corresponding to the multicast broadcast service communication session established in act 1410 to at least one non-terrestrial radio network node.

At act 1420, at least one of the at least one terrestrial radio network node may transmit at least one terrestrial radio channel performance parameter value report request to at least one user equipment that may be conducting, participating in, or otherwise receiving traffic corresponding to the multicast broadcast service communication session established at 1410. Responsive to the parameter value report request transmitted by at least one terrestrial radio network node at act 1420, at act 1425 at least one of the at least one user equipment may measure, or determine, at least one terrestrial radio performance parameter value corresponding to at least one terrestrial radio performance parameter indicated in a report request transmitted at act 1420. The terrestrial radio performance parameters may be associated with a QC type. The at least one user equipment may transmit a measured/determined terrestrial radio performance parameter value via a radio performance parameter report to at least one terrestrial radio network node that transmitted a parameter value report requested act 1420.

At act 1430, at least one terrestrial radio network node may determine at least one non-terrestrial radio network node corresponding to a non-terrestrial geographic area coverage footprint that overlaps with a terrestrial geographic area coverage footprint corresponding to the at least one terrestrial radio network node to result in an at least one determined non-terrestrial radio network node. At act 1435, at least one terrestrial radio network node may transmit a delegated traffic delivery request, for example request 315 described in reference to FIG. 3, to the at least one determined non-terrestrial radio network node.

At act 1440, responsive to the delegated traffic delivery request transmitted at act 1435, at least one of the at least one determined non-terrestrial radio network node may determine whether the request is indicative of transparent delegation of traffic associated with the multicast broadcast service communication session established at act 1410. If a determination is made at act 1440 that a request transmitted at act 1435 does not indicate transparent delegation, method 1400 may advance to act 1450. At act 1450, at least one determined non-terrestrial radio network node may determine a non-terrestrial QCI information type and other transmission configuration information that may be usable to facilitate delivery of delegated traffic corresponding to the multicast broadcast service communication session established that act 1410 to at least one user equipment. In an embodiment, user equipment with respect to which delegation of MBS traffic is not specified in a request transmitted at act 1435 to be transparent (e.g., the delegation of the MBS traffic is indicated to be non-transparent) may be non-terrestrial-capable user equipment. At act 1455, the at least one determined non-terrestrial radio network node may transmit, to at least one terrestrial radio network node, a non-terrestrial radio channel performance parameter adjustment message, for example message 330 described in reference to FIG. 3, comprising an information object (e.g., object 610 described in reference to FIG. 7) indicative of the non-terrestrial QCI type or other transmission configuration information determined at act 1450. At act 1460, a terrestrial radio network node that receives a radio channel performance parameter adjustment message transmitted by a non-terrestrial radio network node at act 1455 may transmit to at least one user equipment a radio channel performance parameter adjustment value message, for example message 335 described in reference to FIG. 3. A radio channel performance parameter adjustment value message may comprise information indicated in information object 610 if a delegated traffic delivery request message transmitted at act 1435 is indicative of non-transparent delegation of at least a portion of a multicast broadcast service communication session established at act 1410.

Returning to description of act 1440, if a determination is made that a delegated traffic delivery request message transmitted at act 1435 is indicative of transparent delegation of MBS traffic corresponding to the MBS communication session established act 1410, a non-terrestrial network node that received a delegated traffic delivery request message transmitted at act 1435 may determine at act 1445 at least one offset value, or adjustment, value. An offset or adjustment value determined by a non-terrestrial network node at act 1445 may correspond to a radio performance parameter, requested at act 1420 and with respect to which a measured value is determined at act 1425 by a user equipment. Thus, an offset value or an adjustment value determined by a non-terrestrial network node at act 1445 may correspond to a difference with respect to a radio performance parameter corresponding to delivery of traffic to a user equipment by a terrestrial radio network node compared to delivery of traffic to the user equipment by the non-terrestrial radio network node. An offset/adjustment value may be usable by user equipment to receive delegated traffic corresponding to the MBS session established at act 1410 by adjusting configuration information at the user equipment by the offset/adjustment value. At act 1455, a non-terrestrial network node that determined at least one offset/adjustment value at act 1445 may transmit the determined at least one offset/adjustment value via a radio channel performance parameter adjustment message at act 1455. A radio channel performance parameter adjustment message may comprise an offset information object, for example information object 605 described in reference to FIG. 7, if a delegation request message transmitted by a terrestrial radio network node at 1435 is indicative of transparent delivery of delegated traffic corresponding to an MBS session established at act 1410. At act 1460, a terrestrial radio network node that received a radio channel performance parameter adjustment message transmitted by a non-terrestrial radio network node at act 1455 may transmit to at least one user equipment a radio channel performance parameter adjustment value message, for example message 335 described in reference to FIG. 3. A radio channel performance parameter adjustment value message may comprise offset information indicated in information object 605 if a delegated traffic delivery request message transmitted at act 1435 is indicative of transparent delegation of at least a portion of a multicast broadcast service communication session established at act 1410.

At act 1465, a user equipment that receives a radio channel performance parameter adjustment value message transmitted by a terrestrial radio network node at 1460 may determine whether the performance parameter adjustment value message comprises an indication indicative of transparent delegation of delivery of traffic. A user equipment may determine whether a radio channel performance parameter adjustment value messages indicative of transparent delegation based on inclusion in the radio channel performance parameter adjustment value message of QCI offset information. For example, if a radio channel performance parameter adjustment value message comprises offset information in field 905 shown in FIG. 9, a user equipment that receives message 335 may determine that message 335 is indicative of transparent delegation. If the user equipment determines at act 1465 that a radio channel performance parameter adjustment value message is indicative of transparent delegation, at act 1470 the user equipment may adjust configuration information according to parameter offset/adjustment values to result in adjusted parameter values and may receive, at act 1475, delegated downlink data traffic corresponding to a multicast broadcast service communication session established at act 1410 based on the adjusted parameter values and according to terrestrial resources, for example frequency or time resources, that may have been scheduled at act 1410 to facilitate terrestrial delivery, by a terrestrial radio network node, of the now-delegated MBS data traffic. At act 1485, a determination may be made whether a delegation period corresponding to delegation of MBS traffic has expired. If a determination is made that the delegation period has not expired, the user equipment may continue to receive the delegated MBS traffic at act 1490. If a determination is made that the delegation period has expired, method 1400 may advance to act 1495 and end.

Returning to description of act 1465, if a user equipment determines that a radio channel performance parameter adjustment value message transmitted by a terrestrial radio network node at act 1465 does not indicate transparent delegation (e.g., non-transparent traffic delegation may be indicated in field 910 of message 335 as shown in FIG. 9), at act 1480, the user equipment may establish a connection with a non-terrestrial radio network node indicated in message 335, for example in field 910 of message 335, which may be, or may not be, a temporary connection. If a connection established at act 1480 is not a temporary connection, terrestrial radio network node may flush information corresponding to the communication session established at act 1410. The user equipment may establish a connection with a non-terrestrial radio network node at act 1480 as indicated in field 910 of message 335, based on non-terrestrial information corresponding to the non-terrestrial network node indicated by message 335, which non-terrestrial information may be information included in information object 610 that may be indicated via a message 330 by the non-terrestrial network node to the terrestrial network node that transmitted the radio channel performance parameter adjustment value message to the user equipment at act 1460. In an embodiment, if a connection established at act 1480 is not a temporary connection, user equipment may continue to receive traffic from the non-terrestrial network node identified in field 910 of message 335, method 1400 may advance to act 1495 and end. In an embodiment, if a connection established at act 1480 is a temporary connection, at act 1485, a determination may be made whether a delegation period corresponding to delegation of MBS traffic has expired. If a determination is made that the delegation period has not expired, the user equipment continues to receive the delegated MBS traffic at act 1490. If a determination is made that the delegation period has expired, method 1400 may advance to act 1495 and end.

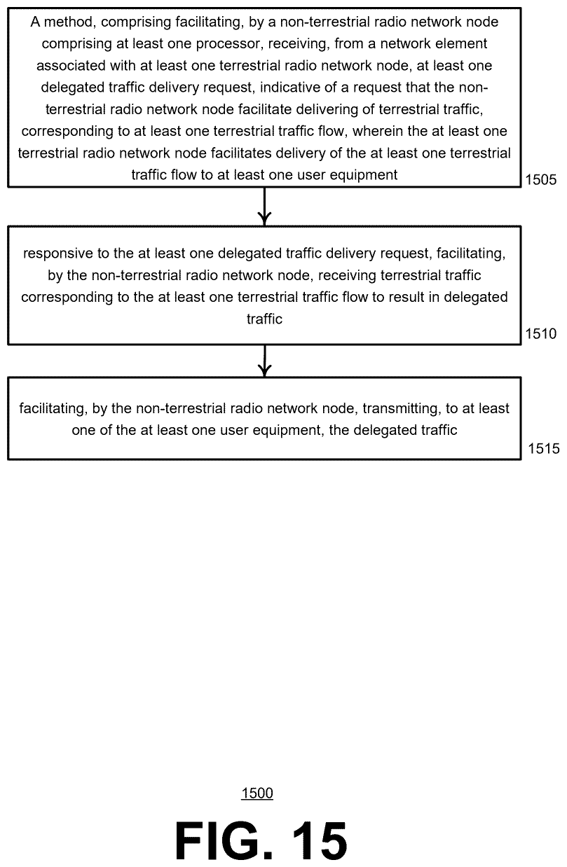

Turning now to FIG. 15, the figure illustrates an example embodiment method 1500 comprising at block 1505 facilitating, by a non-terrestrial radio network node comprising at least one processor, receiving, from a network element associated with at least one terrestrial radio network node, at least one delegated traffic delivery request, indicative of a request that the non-terrestrial radio network node facilitate delivering of terrestrial traffic, corresponding to at least one terrestrial traffic flow, wherein the at least one terrestrial radio network node facilitates delivery of the at least one terrestrial traffic flow to at least one user equipment; at block 1510 responsive to the at least one delegated traffic delivery request, facilitating, by the non-terrestrial radio network node, receiving terrestrial traffic corresponding to the at least one terrestrial traffic flow to result in delegated traffic; and at block 1515 facilitating, by the non-terrestrial radio network node, transmitting, to at least one of the at least one user equipment, the delegated traffic.

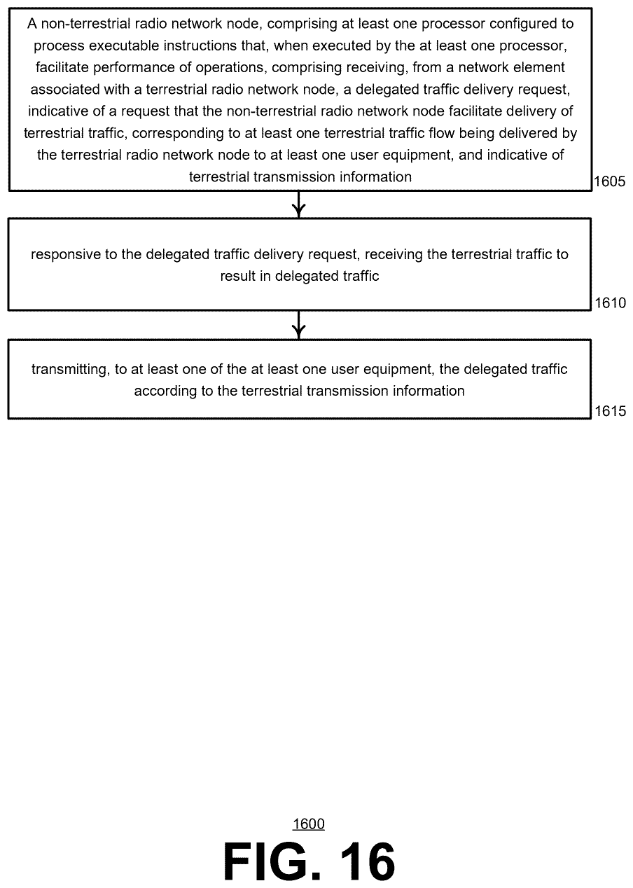

Turning now to FIG. 16, the figure illustrates a non-terrestrial radio network node 1600, comprising at block 1605 at least one processor configured to process executable instructions that, when executed by the at least one processor, facilitate performance of operations, comprising receiving, from a network element associated with a terrestrial radio network node, a delegated traffic delivery request, indicative of a request that the non-terrestrial radio network node facilitate delivery of terrestrial traffic, corresponding to at least one terrestrial traffic flow being delivered by the terrestrial radio network node to at least one user equipment, and indicative of terrestrial transmission information; at block 1610 responsive to the delegated traffic delivery request, receiving the terrestrial traffic to result in delegated traffic; and at block 1615 transmitting, to at least one of the at least one user equipment, the delegated traffic according to the terrestrial transmission information.

Turning now to FIG. 17 the figure illustrates a non-transitory machine-readable medium 1700 comprising at block 1705 executable instructions that, when executed by at least one processor of a non-terrestrial radio network node, facilitate performance of operations, comprising receiving, from a network element associated with a terrestrial radio network node, a delegated traffic delivery request, indicative of a request that the non-terrestrial radio network node facilitate delivery of terrestrial data traffic, corresponding to at least one terrestrial multicast traffic flow being delivered by the terrestrial radio network node to at least one user equipment, and indicative of terrestrial transmission information; at block 1710 responsive to the delegated traffic delivery request, receiving multicast data traffic corresponding to the at least one terrestrial multicast traffic flow to result in delegated multicast data traffic; and at block 1715 transmitting, to at least one of the at least one user equipment, the delegated multicast data traffic according to the terrestrial transmission information.

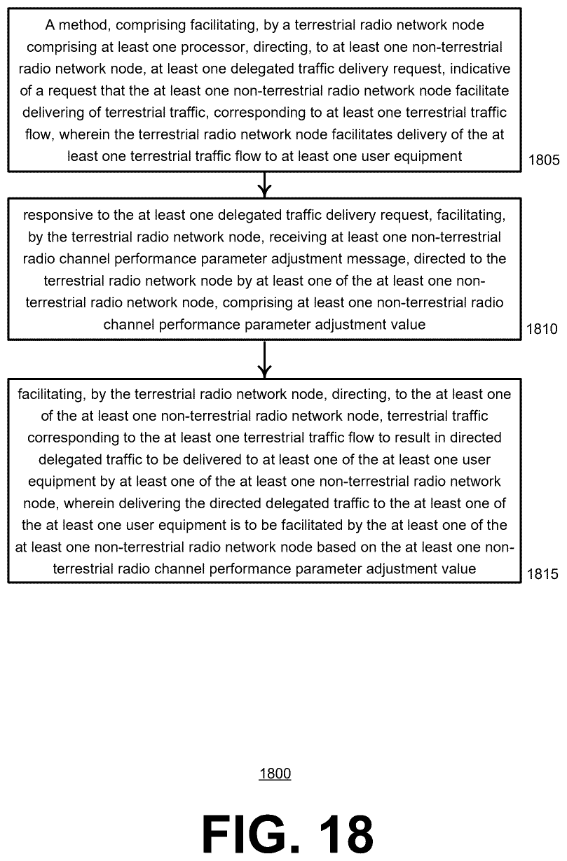

Turning now to FIG. 18, the figure illustrates an example embodiment method 1800 comprising, at block 1805, facilitating, by a terrestrial radio network node comprising at least one processor, directing, to at least one non-terrestrial radio network node, at least one delegated traffic delivery request, indicative of a request that the at least one non-terrestrial radio network node facilitate delivering of terrestrial traffic, corresponding to at least one terrestrial traffic flow, wherein the terrestrial radio network node facilitates delivery of the at least one terrestrial traffic flow to at least one user equipment; at block 1810 responsive to the at least one delegated traffic delivery request, facilitating, by the terrestrial radio network node, receiving at least one non-terrestrial radio channel performance parameter adjustment message, directed to the terrestrial radio network node by at least one of the at least one non-terrestrial radio network node, comprising at least one non-terrestrial radio channel performance parameter adjustment value; and at block facilitating, by the terrestrial radio network node, directing, to the at least one of the at least one non-terrestrial radio network node, terrestrial traffic corresponding to the at least one terrestrial traffic flow to result in directed delegated traffic to be delivered to at least one of the at least one user equipment by at least one of the at least one non-terrestrial radio network node, wherein delivering the directed delegated traffic to the at least one of the at least one user equipment is to be facilitated by the at least one of the at least one non-terrestrial radio network node based on the at least one non-terrestrial radio channel performance parameter adjustment value.

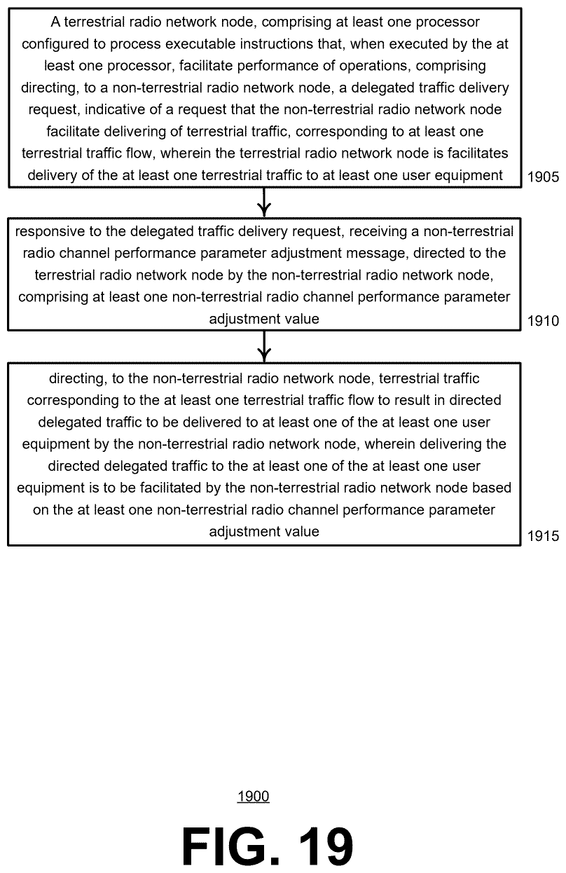

Turning now to FIG. 19, the figure illustrates an example terrestrial radio network node 1900, comprising at block 1905 at least one processor configured to process executable instructions that, when executed by the at least one processor, facilitate performance of operations comprising directing, to a non-terrestrial radio network node, a delegated traffic delivery request, indicative of a request that the non-terrestrial radio network node facilitate delivering of terrestrial traffic, corresponding to at least one terrestrial traffic flow, wherein the terrestrial radio network node is facilitates delivery of the at least one terrestrial traffic to at least one user equipment; at block 1910 responsive to the delegated traffic delivery request, receiving a non-terrestrial radio channel performance parameter adjustment message, directed to the terrestrial radio network node by the non-terrestrial radio network node, comprising at least one non-terrestrial radio channel performance parameter adjustment value; and at block directing, to the non-terrestrial radio network node, terrestrial traffic corresponding to the at least one terrestrial traffic flow to result in directed delegated traffic to be delivered to at least one of the at least one user equipment by the non-terrestrial radio network node, wherein delivering the directed delegated traffic to the at least one of the at least one user equipment is to be facilitated by the non-terrestrial radio network node based on the at least one non-terrestrial radio channel performance parameter adjustment value.

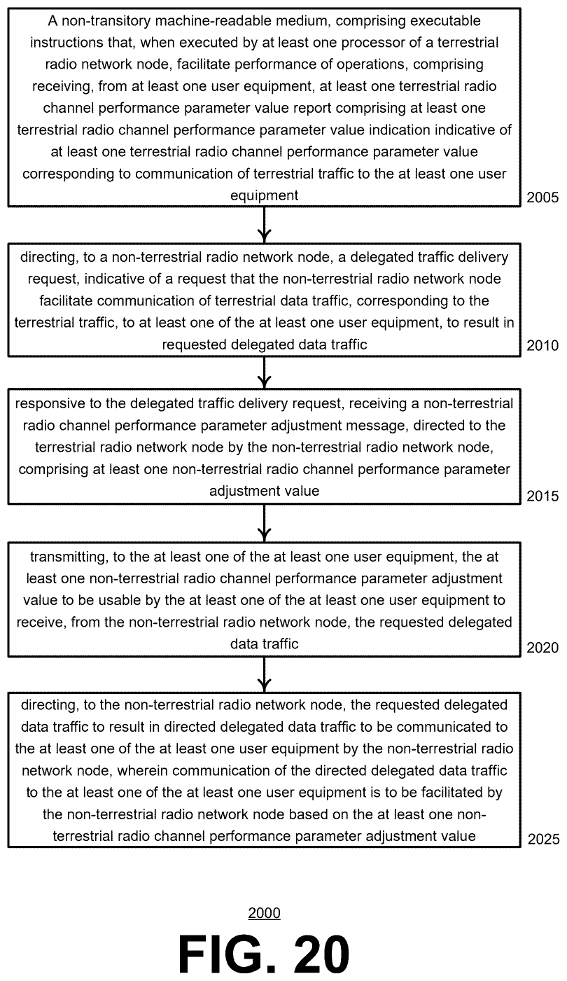

Turning now to FIG. 20, the figure illustrates a non-transitory machine-readable medium 2000 comprising at block 2005 executable instructions that, when executed by at least one processor of a terrestrial radio network node, facilitate performance of operations, comprising receiving, from at least one user equipment, at least one terrestrial radio channel performance parameter value report comprising at least one terrestrial radio channel performance parameter value indication indicative of at least one terrestrial radio channel performance parameter value corresponding to communication of terrestrial traffic to the at least one user equipment; at block 2010 directing, to a non-terrestrial radio network node, a delegated traffic delivery request, indicative of a request that the non-terrestrial radio network node facilitate communication of terrestrial data traffic, corresponding to the terrestrial traffic, to at least one of the at least one user equipment, to result in requested delegated data traffic; at block 2015 responsive to the delegated traffic delivery request, receiving a non-terrestrial radio channel performance parameter adjustment message, directed to the terrestrial radio network node by the non-terrestrial radio network node, comprising at least one non-terrestrial radio channel performance parameter adjustment value; at block 2020 transmitting, to the at least one of the at least one user equipment, the at least one non-terrestrial radio channel performance parameter adjustment value to be usable by the at least one of the at least one user equipment to receive, from the non-terrestrial radio network node, the requested delegated data traffic; and at block 2025 directing, to the non-terrestrial radio network node, the requested delegated data traffic to result in directed delegated data traffic to be communicated to the at least one of the at least one user equipment by the non-terrestrial radio network node, wherein communication of the directed delegated data traffic to the at least one of the at least one user equipment is to be facilitated by the non-terrestrial radio network node based on the at least one non-terrestrial radio channel performance parameter adjustment value.

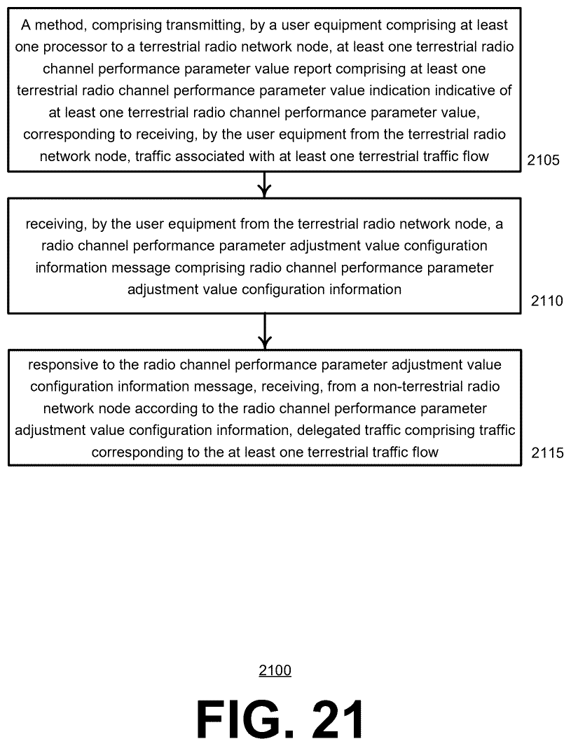

Turning now to FIG. 21, the figure illustrates an example embodiment method 2100 comprising, at block 2105, transmitting, by a user equipment comprising at least one processor to a terrestrial radio network node, at least one terrestrial radio channel performance parameter value report comprising at least one terrestrial radio channel performance parameter value indication indicative of at least one terrestrial radio channel performance parameter value, corresponding to receiving, by the user equipment from the terrestrial radio network node, traffic associated with at least one terrestrial traffic flow; at block 2110 receiving, by the user equipment from the terrestrial radio network node, a radio channel performance parameter adjustment value configuration information message comprising radio channel performance parameter adjustment value configuration information; and at block 2115 responsive to the radio channel performance parameter adjustment value configuration information message, receiving, from a non-terrestrial radio network node according to the radio channel performance parameter adjustment value configuration information, delegated traffic comprising traffic corresponding to the at least one terrestrial traffic flow.

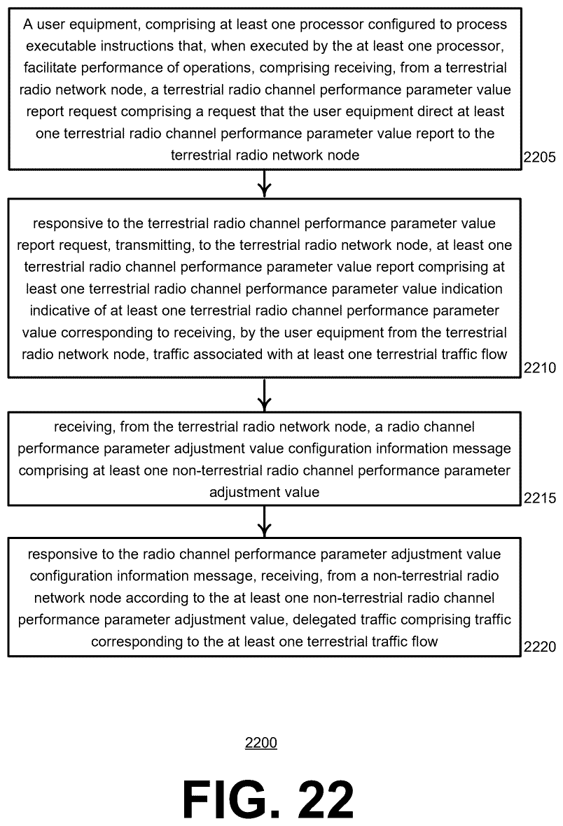

Turning now to FIG. 22, the figure illustrates an example user equipment 2200, comprising at block 2205 at least one processor configured to process executable instructions that, when executed by the at least one processor, facilitate performance of operations comprising receiving, from a terrestrial radio network node, a terrestrial radio channel performance parameter value report request comprising a request that the user equipment direct at least one terrestrial radio channel performance parameter value report to the terrestrial radio network node; at block 2210 responsive to the terrestrial radio channel performance parameter value report request, transmitting, to the terrestrial radio network node, at least one terrestrial radio channel performance parameter value report comprising at least one terrestrial radio channel performance parameter value indication indicative of at least one terrestrial radio channel performance parameter value corresponding to receiving, by the user equipment from the terrestrial radio network node, traffic associated with at least one terrestrial traffic flow; at block 2215 receiving, from the terrestrial radio network node, a radio channel performance parameter adjustment value configuration information message comprising at least one non-terrestrial radio channel performance parameter adjustment value; and at block 2220 responsive to the radio channel performance parameter adjustment value configuration information message, receiving, from a non-terrestrial radio network node according to the at least one non-terrestrial radio channel performance parameter adjustment value, delegated traffic comprising traffic corresponding to the at least one terrestrial traffic flow.

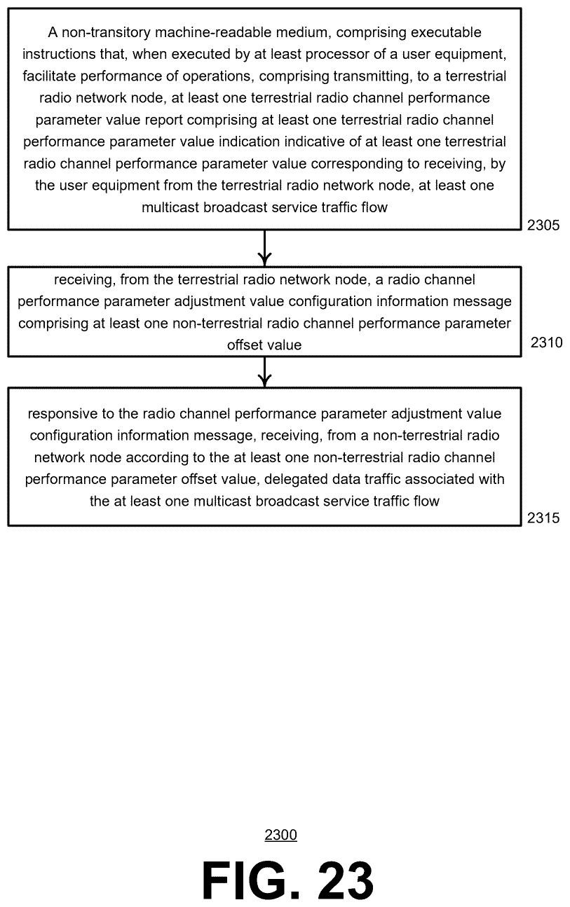

Turning now to FIG. 23, the figure illustrates a non-transitory machine-readable medium 2300 comprising at block 2305 executable instructions that, when executed by at least one processor of a user equipment, facilitate performance of operations, comprising transmitting, to a terrestrial radio network node, at least one terrestrial radio channel performance parameter value report comprising at least one terrestrial radio channel performance parameter value indication indicative of at least one terrestrial radio channel performance parameter value corresponding to receiving, by the user equipment from the terrestrial radio network node, at least one multicast broadcast service traffic flow; at block 2310 receiving, from the terrestrial radio network node, a radio channel performance parameter adjustment value configuration information message comprising at least one non-terrestrial radio channel performance parameter offset value; and at block 2315 responsive to the radio channel performance parameter adjustment value configuration information message, receiving, from a non-terrestrial radio network node according to the at least one non-terrestrial radio channel performance parameter offset value, delegated data traffic associated with the at least one multicast broadcast service traffic flow.

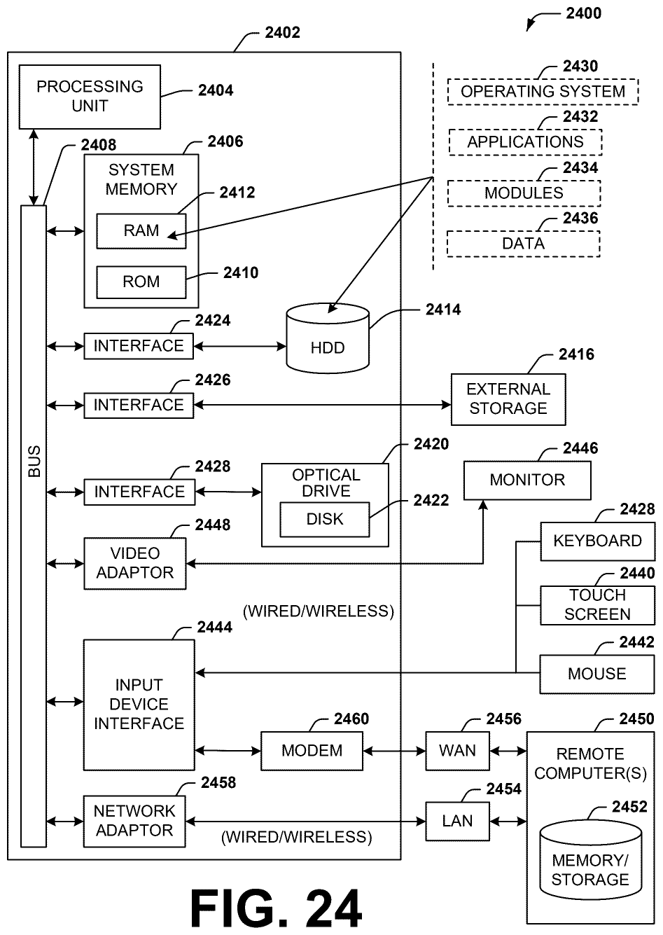

In order to provide additional context for various embodiments described herein, FIG. 24 and the following discussion are intended to provide a brief, general description of a suitable computing environment 2400 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 24, the example environment 2400 for implementing various embodiments of the aspects described herein includes a computer 2402, the computer 2402 including a processing unit 2404, a system memory 2406 and a system bus 2408. The system bus 2408 couples system components including, but not limited to, the system memory 2406 to the processing unit 2404. The processing unit 2404 can be any of various commercially available processors and may include a cache memory. Dual microprocessors and other multi-processor architectures can also be employed as the processing unit 2404.

The system bus 2408 can be any of several types of bus structure that can further interconnect to a memory bus (with or without a memory controller), a peripheral bus, and a local bus using any of a variety of commercially available bus architectures. The system memory 2406 includes ROM 2410 and RAM 2412. A basic input/output system (BIOS) can be stored in a non-volatile memory such as ROM, erasable programmable read only memory (EPROM), EEPROM, which BIOS contains the basic routines that help to transfer information between elements within the computer 2402, such as during startup. The RAM 2412 can also include a high-speed RAM such as static RAM for caching data.

Computer 2402 further includes an internal hard disk drive (HDD) 2414 (e.g., EIDE, SATA), one or more external storage devices 2416 (e.g., a magnetic floppy disk drive (FDD) 2416, a memory stick or flash drive reader, a memory card reader, etc.) and an optical disk drive 2420 (e.g., which can read or write from a CD-ROM disc, a DVD, a BD, etc.). While the internal HDD 2414 is illustrated as located within the computer 2402, the internal HDD 2414 can also be configured for external use in a suitable chassis (not shown). Additionally, while not shown in environment 2400, a solid-state drive (SSD) could be used in addition to, or in place of, an HDD 2414. The HDD 2414, external storage device(s) 2416 and optical disk drive 2420 can be connected to the system bus 2408 by an HDD interface 2424, an external storage interface 2426 and an optical drive interface 2428, respectively. The interface 2424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2412, including an operating system 2430, one or more application programs 2432, other program modules 2434 and program data 2436. All or portions of the operating system, applications, modules, and/or data can also be cached in the RAM 2412. The systems and methods described herein can be implemented utilizing various commercially available operating systems or combinations of operating systems.

Computer 2402 can optionally comprise emulation technologies. For example, a hypervisor (not shown) or other intermediary can emulate a hardware environment for operating system 2430, and the emulated hardware can optionally be different from the hardware illustrated in FIG. 24. In such an embodiment, operating system 2430 can comprise one virtual machine (VM) of multiple VMs hosted at computer 2402. Furthermore, operating system 2430 can provide runtime environments, such as the Java runtime environment or the .NET framework, for applications 2432. Runtime environments are consistent execution environments that allow applications 2432 to run on any operating system that includes the runtime environment. Similarly, operating system 2430 can support containers, and applications 2432 can be in the form of containers, which are lightweight, standalone, executable packages of software that include, e.g., code, runtime, system tools, system libraries and settings for an application.

Further, computer 2402 can comprise a security module, such as a trusted processing module (TPM). For instance, with a TPM, boot components hash next in time boot components, and wait for a match of results to secured values, before loading a next boot component. This process can take place at any layer in the code execution stack of computer 2402, e.g., applied at the application execution level or at the operating system (OS) kernel level, thereby enabling security at any level of code execution.

A user can enter commands and information into the computer 2402 through one or more wired/wireless input devices, e.g., a keyboard 2438, a touch screen 2440, and a pointing device, such as a mouse 2442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2404 through an input device interface 2444 that can be coupled to the system bus 2408, but can be connected by other interfaces, such as a parallel port, an IEEE 1394 serial port, a game port, a USB port, an IR interface, a BLUETOOTH® interface, etc.

A monitor 2446 or other type of display device can be also connected to the system bus 2408 via an interface, such as a video adapter 2448. In addition to the monitor 2446, a computer typically includes other peripheral output devices (not shown), such as speakers, printers, etc.

The computer 2402 can operate in a networked environment using logical connections via wired and/or wireless communications to one or more remote computers, such as a remote computer(s) 2450. The remote computer(s) 2450 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory/storage device 2452 is illustrated. The logical connections depicted include wired/wireless connectivity to a local area network (LAN) 2454 and/or larger networks, e.g., a wide area network (WAN) 2456. Such LAN and WAN networking environments are commonplace in offices and companies, and facilitate enterprise-wide computer networks, such as intranets, all of which can connect to a global communications network, e.g., the internet.

When used in a LAN networking environment, the computer 2402 can be connected to the local network 2454 through a wired and/or wireless communication network interface or adapter 2458. The adapter 2458 can facilitate wired or wireless communication to the LAN 2454, which can also include a wireless access point (AP) disposed thereon for communicating with the adapter 2458 in a wireless mode.

When used in a WAN networking environment, the computer 2402 can include a modem 2460 or can be connected to a communications server on the WAN 2456 via other means for establishing communications over the WAN 2456, such as by way of the internet. The modem 2460, which can be internal or external and a wired or wireless device, can be connected to the system bus 2408 via the input device interface 2444. In a networked environment, program modules depicted relative to the computer 2402 or portions thereof, can be stored in the remote memory/storage device 2452. It will be appreciated that the network connections shown are example and other means of establishing a communications link between the computers can be used.

When used in either a LAN or WAN networking environment, the computer 2402 can access cloud storage systems or other network-based storage systems in addition to, or in place of, external storage devices 2416 as described above. Generally, a connection between the computer 2402 and a cloud storage system can be established over a LAN 2454 or WAN 2456 e.g., by the adapter 2458 or modem 2460, respectively. Upon connecting the computer 2402 to an associated cloud storage system, the external storage interface 2426 can, with the aid of the adapter 2458 and/or modem 2460, manage storage provided by the cloud storage system as it would other types of external storage. For instance, the external storage interface 2426 can be configured to provide access to cloud storage sources as if those sources were physically connected to the computer 2402.

The computer 2402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

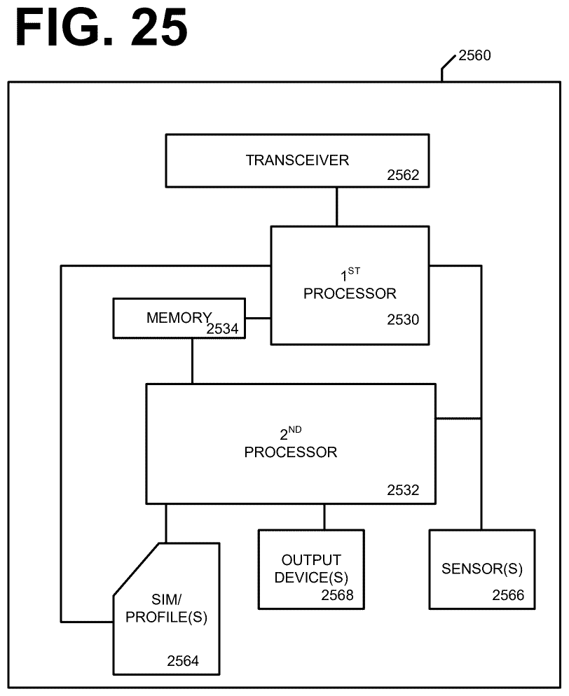

Turning to FIG. 25, the figure illustrates a block diagram of an example UE 2560. UE 2560 may comprise a smart phone, a wireless tablet, a laptop computer with wireless capability, a wearable device, a machine device that may facilitate vehicle telematics, a tracking device, remote sensing devices, and the like. UE 2560 comprises a first processor 2530, a second processor 2532, and a shared memory 2534. UE 2560 includes radio front end circuitry 2562, which may be referred to herein as a transceiver, but is understood to typically include transceiver circuitry, separate filters, and separate antennas for facilitating transmission and receiving of signals over a wireless link, such as one or more wireless links 125, 135, and 137 shown in FIG. 1. Furthermore, transceiver 2562 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 25, UE 2560 may also include a SIM 2564, or a SIM profile, which may comprise information stored in a memory (memory 2534 or a separate memory portion), for facilitating wireless communication with RAN 105 or core network 130 shown in FIG. 1. FIG. 25 shows SIM 2564 as a single component in the shape of a conventional SIM card, but it will be appreciated that SIM 2564 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 2564 and another device, which may be a component of RAN 105 or core network 130 shown in FIG. 1). A SIM profile 2564 may also comprise identifying information that is unique to the SIM, or SIM profile, such as, for example, an International Mobile Subscriber Identity (“IMSI”) or information that may make up an IMSI.

SIM 2564 is shown coupled to both the first processor portion 2530 and the second processor portion 2532. Such an implementation may provide an advantage that first processor portion 2530 may not need to request or receive information or data from SIM 2564 that second processor 2532 may request, thus eliminating the use of the first processor acting as a ‘go-between’ when the second processor uses information from the SIM in performing its functions and in executing applications. First processor 2530, which may be a modem processor or a baseband processor, is shown smaller than processor 2532, which may be a more sophisticated application processor, to visually indicate the relative levels of sophistication (i.e., processing capability and performance) and corresponding relative levels of operating power consumption levels between the two processor portions. Keeping the second processor portion 2532 asleep/inactive/in a low power state when UE 2560 does not need it for executing applications and processing data related to an application provides an advantage of reducing power consumption when the UE only needs to use the first processor portion 2530 while in listening mode for monitoring routine configured bearer management and mobility management/maintenance procedures, or for monitoring search spaces that the UE has been configured to monitor while the second processor portion remains inactive/asleep.

UE 2560 may also include sensors 2566, such as, for example, temperature sensors, accelerometers, gyroscopes, barometers, moisture sensors, and the like that may provide signals to the first processor 2530 or second processor 2532. Output devices 2568 may comprise, for example, one or more visual displays (e.g., computer monitors, VR appliances, and the like), acoustic transducers, such as speakers or microphones, vibration components, and the like. Output devices 2568 may comprise software that interfaces with output devices, for example, visual displays, speakers, microphones, touch sensation devices, smell or taste devices, and the like, that are external to UE 2560.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency |
| | communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network |
| | temporary identifier |
| CRC | Cyclic redundancy check |
| MIMO | Multi input multi output |
| AI | Artificial intelligence |
| ML | Machine learning |
| QCI | QoS Class Identifiers |
| BSR | Buffer status report |
| SBFD | Sub-band full duplex |
| CLI | Cross link interference |
| TDD | Time division duplexing |
| FDD | Frequency division duplexing |
| AI | Artificial intelligence |
| ML | Machine learning |
| MCS | Modulation and coding scheme |
| IE | Information element |
| BS | Base station |
| RRC | Radio resource control |
| UCI | Uplink control information |
| UE | User equipment |
| WTRU | Wireless transmit receive unit |
| CBR | Channel busy ratio |
| SCI | Sidelink control information |
| QoS | Quality of service |
| PER | Packet error rate |
| PDB | Packet delay budget |
| E2E | End to end |
| NES | Network energy saving |
| QCI | Quality class indication |
| RSRP | Reference signal received power |
| PCI | Primary cell ID |
| CSI-RS | Channel state information reference signals |
| PTRS | Phase tracking reference signals |
| DTX | Discontinuous transmission |
| | or discontinuous transmit |
| DRX | Discontinuous reception or |
| | discontinuous receive |
| CG | Configured grant |
| ULP | Uplink power |
| FBS | Fake base station |
| NTN | Non terrestrial network |
| gRAN | Ground radio access network |
| RAN | Radio access network |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
transmitting, by a user equipment comprising at least one processor to a terrestrial radio network node, at least one terrestrial radio channel performance parameter value report comprising at least one terrestrial radio channel performance parameter value indication indicative of at least one terrestrial radio channel performance parameter value, corresponding to receiving, by the user equipment from the terrestrial radio network node, traffic associated with at least one terrestrial traffic flow;
receiving, by the user equipment from the terrestrial radio network node, a radio channel performance parameter adjustment value configuration information message comprising radio channel performance parameter adjustment value configuration information; and
responsive to the radio channel performance parameter adjustment value configuration information message, receiving, from a non-terrestrial radio network node according to the radio channel performance parameter adjustment value configuration information, delegated traffic comprising traffic corresponding to the at least one terrestrial traffic flow.

2. The method of claim 1, wherein the radio channel performance parameter adjustment value configuration information comprises at least one non-terrestrial radio channel performance parameter adjustment value corresponding to delivery, by the non-terrestrial radio network node, of traffic to different user equipment.

3. The method of claim 1, wherein the at least one terrestrial radio channel performance parameter value comprises at least one of: a terrestrial doppler shift value, a terrestrial doppler spread value, a terrestrial delay value, or a terrestrial delay spread value, and wherein the radio channel performance parameter adjustment value configuration information is based on at least one of: a non-terrestrial doppler shift value, a non-terrestrial doppler spread value, a non-terrestrial delay value, or a non-terrestrial delay spread value.

4. The method of claim 1, wherein the user equipment is incapable of establishing a connection with the non-terrestrial radio network node, wherein the radio channel performance parameter adjustment value configuration information comprises at least one non-terrestrial adjustment value, and wherein the method further comprises:
applying, by the user equipment, the at least one non-terrestrial adjustment value to the at least one terrestrial radio channel performance parameter value to result in at least one adjusted radio channel performance parameter value,
wherein the receiving of the delegated traffic further comprises:
receiving the delegated traffic according to at least one terrestrial resource, with respect to which the user equipment is configured to receive, from the terrestrial radio network node, the at least one terrestrial traffic flow, and according to the at least one adjusted radio channel performance parameter value.

5. The method of claim 4, wherein the at least one terrestrial resource comprises at least one of: a terrestrial frequency or a terrestrial scheduled time.

6. The method of claim 4, wherein the at least one non-terrestrial adjustment value comprises at least one of: a non-terrestrial doppler shift adjustment value, a non-terrestrial doppler spread adjustment value, a non-terrestrial delay adjustment value, or a non-terrestrial delay spread adjustment value.

7. The method of claim 4, wherein the applying of the at least one non-terrestrial adjustment value to the at least one terrestrial radio channel performance parameter value to result in the at least one adjusted radio channel performance parameter value further comprises:
applying the at least one non-terrestrial adjustment value to the at least one terrestrial radio channel performance parameter value according to a terrestrial quasi colocation information type corresponding to the at least one terrestrial traffic flow.

8. The method of claim 4, wherein the delegated traffic comprises data traffic corresponding to the at least one terrestrial traffic flow, and wherein the method further comprises:
receiving, by the user equipment from the terrestrial radio network node, control channel traffic corresponding to the at least one terrestrial traffic flow according to the at least one terrestrial radio channel performance parameter value.

9. The method of claim 8, wherein the user equipment receives the delegated traffic according to a terrestrial quasi colocation information type corresponding to the at least one terrestrial traffic flow, and wherein the user equipment receives the control channel traffic according to the terrestrial quasi colocation information type.

10. The method of claim 1, wherein the radio channel performance parameter adjustment value configuration information comprises at least one of: a non-terrestrial switching request indication, indicative of a non-terrestrial radio network node identifier corresponding to the non-terrestrial radio network node, and indicative that the user equipment is to establish a connection with the non-terrestrial radio network node to at least receive the at least one terrestrial traffic flow from the non-terrestrial radio network node via non-terrestrial resources; or a non-terrestrial quasi colocation type indication indicative of a non-terrestrial quasi colocation type usable for receiving of traffic associated with the at least one terrestrial traffic flow from the non-terrestrial radio network node via non-terrestrial resources.

11. The method of claim 10, wherein the user equipment is capable of establishing a connection with the non-terrestrial radio network node, and wherein the method further comprises:
responsive to the non-terrestrial switching request indication, establishing, by the user equipment, a connection with the non-terrestrial radio network node to result in an established non-terrestrial connection; and
flushing, by the user equipment, terrestrial quasi colocation type information usable by the user equipment to receive the at least one terrestrial traffic flow from the terrestrial radio network node,
wherein the delegated traffic is received via the established non-terrestrial connection.

12. The method of claim 11, wherein the established non-terrestrial connection is established according to the non-terrestrial quasi colocation type indicated in the radio channel performance parameter adjustment value configuration information.

13. The method of claim 11, wherein the delegated traffic comprises data traffic and control channel traffic associated with the at least one terrestrial traffic flow.

14. A user equipment, comprising:
at least one processor configured to process executable instructions that, when executed by the at least one processor, facilitate performance of operations, comprising:
receiving, from a terrestrial radio network node, a terrestrial radio channel performance parameter value report request comprising a request that the user equipment direct at least one terrestrial radio channel performance parameter value report to the terrestrial radio network node;
responsive to the terrestrial radio channel performance parameter value report request, transmitting, to the terrestrial radio network node, at least one terrestrial radio channel performance parameter value report comprising at least one terrestrial radio channel performance parameter value indication indicative of at least one terrestrial radio channel performance parameter value corresponding to receiving, by the user equipment from the terrestrial radio network node, traffic associated with at least one terrestrial traffic flow;
receiving, from the terrestrial radio network node, a radio channel performance parameter adjustment value configuration information message comprising at least one non-terrestrial radio channel performance parameter adjustment value; and
responsive to the radio channel performance parameter adjustment value configuration information message, receiving, from a non-terrestrial radio network node according to the at least one non-terrestrial radio channel performance parameter adjustment value, delegated traffic comprising traffic corresponding to the at least one terrestrial traffic flow.

15. The user equipment of claim 14, wherein the at least one terrestrial radio channel performance parameter value comprises at least one of: a terrestrial doppler shift value, a terrestrial doppler spread value, a terrestrial delay value, or a terrestrial delay spread value, and wherein the at least one non-terrestrial radio channel performance parameter adjustment value comprises at least one of: a non-terrestrial doppler shift offset value, a non-terrestrial doppler spread offset value, a non-terrestrial delay offset value, or a non-terrestrial delay spread offset value.

16. The user equipment of claim 14, wherein the operations further comprise:
applying the at least one non-terrestrial radio channel performance parameter adjustment value to the at least one terrestrial radio channel performance parameter value to result in at least one adjusted radio channel performance parameter value,
wherein the delegated traffic is received according to at least one terrestrial resource, with respect to which the user equipment is configured to receive, from the terrestrial radio network node, the at least one terrestrial traffic flow, and according to the at least one adjusted radio channel performance parameter value.

17. The user equipment of claim 14, wherein the delegated traffic comprises delegated data traffic corresponding to the at least one terrestrial traffic flow, and wherein the operations further comprise:
receiving, from the terrestrial radio network node, control channel traffic corresponding to the at least one terrestrial traffic flow according to the at least one terrestrial radio channel performance parameter value.

18. The user equipment of claim 17, wherein the user equipment receives the delegated data traffic according to a terrestrial quasi colocation information type corresponding to the at least one terrestrial traffic flow, and wherein the user equipment receives the control channel traffic corresponding to the at least one terrestrial traffic flow according to the terrestrial quasi colocation information type.

19. A non-transitory machine-readable medium, comprising executable instructions that, when executed by at least processor of a user equipment, facilitate performance of operations, comprising:
transmitting, to a terrestrial radio network node, at least one terrestrial radio channel performance parameter value report comprising at least one terrestrial radio channel performance parameter value indication indicative of at least one terrestrial radio channel performance parameter value corresponding to receiving, by the user equipment from the terrestrial radio network node, at least one multicast broadcast service traffic flow;
receiving, from the terrestrial radio network node, a radio channel performance parameter adjustment value configuration information message comprising at least one non-terrestrial radio channel performance parameter offset value; and
responsive to the radio channel performance parameter adjustment value configuration information message, receiving, from a non-terrestrial radio network node according to the at least one non-terrestrial radio channel performance parameter offset value, delegated data traffic associated with the at least one multicast broadcast service traffic flow.

20. The non-transitory machine-readable medium of claim 19, wherein the delegated data traffic is received according to at least one terrestrial frequency resource, with respect to which the user equipment is configured to receive, from the terrestrial radio network node, the at least one multicast broadcast service traffic flow, wherein the delegated data traffic is received according to the at least one non-terrestrial radio channel performance parameter offset value, and wherein the operations further comprise:
receiving, from the terrestrial radio network node, control channel traffic corresponding to the at least one multicast broadcast service terrestrial traffic flow according to the at least one terrestrial radio channel performance parameter value.
